(19) United States
(12) Patent Application Publication
(10) Pub. No.: US 2005/0060174 A1
(43) Pub. Date: Mar. 17, 2005

(54) Absence management systems and methods

(76) Inventors: Salome M. Heyward, Plymouth, MA (US); Edward Haslam, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/877,008

(22) Filed: Jun. 25, 2004

Related U.S. Application Data
(60) Provisional application No. 60/502,906, filed on Sep. 15, 2003.

(51) Int. Cl. G06F 17/60

(52) U.S. Cl. 705/1

(57) ABSTRACT

Systems and methods are disclosed that, in one embodiment among others, track a leave from employment for an employee and provide return to work information that informs an administrator how to return the employee to work in compliance with employee leave laws.

### CROSS-REFERENCE TO RELATED APPLICATION

This application claims the benefit of U.S. Provisional Application No. 60/502,906, filed Sep. 15, 2003, herein incorporated by reference.

### TECHNICAL FIELD

The present invention is generally related to computer systems and, more particularly, is related to computer systems and methods for managing employee leaves.

### BACKGROUND

Employers are facing an increasingly complex world where management of employee leaves (e.g., absences due to illness, injury, etc.) requires multi-departmental and/or multi-vocational cooperation and a knowledge of applicable laws. For example, compliance coordination issues may need to be addressed between the Family Medical Leave Act (FMLA), the Americans with Disabilities Act (ADA), Worker's Compensation (WC), and/or benefit programs (e.g., short-term disability (STD), long-term disability (LTD), etc.) to minimize conflict and/or erroneous decisions. Further, effective tracking, monitoring, and record keeping strategies should be employed to ensure consistent application of these policies and procedures among diverse departments to avoid unfairness or even litigation.

Over the years, many employers have out-sourced the management of employee leaves. For example, various insurance carriers provide the service of tracking leaves under FMLA. Under current FMLA law, employees receive twelve weeks of leave in a twelve month period. An employer needs to track that leave under FMLA because it is a job protected leave. Generally, an employer should be diligent in keeping records of leaves and also provide records, notices, etc. related to the leave. One problem that can arise under FMLA is that an employee can take what is called intermittent or reduced schedule leave. Tracking such intermittent leave in a twelve week/twelve month period is difficult. Thus, many employers will out-source such tracking to third party administrators, such as insurance companies. One effect of out-sourcing such leave administration is that the employer may be paying for a service that it in part provides. In other words, an employee will typically call the third party administrator when leave is required. Regardless of whether the employer is directly contacted by the employee or not, it is the employer who still has to be informed, and thus the employer often acts as a middle party to inform the third party administrator of the employee absence under FMLA leave.

Related to the above-described problem is the effect on control over employee leave. For example, when an employee is allowed to call a third party administrator versus his or her supervisor, it removes much of the stigma associated with taking time off from work. Typically, the third party has no legal expertise and/or incentive to question a leave request of an employee, creating opportunities for an employee to take advantage of the employer.

### SUMMARY

Preferred embodiments of an absence management system and method are disclosed. In one embodiment, among others, a system is disclosed that tracks a leave from employment for an employee and provides return to work information that informs an administrator how to return the employee to work in compliance with employee leave laws.

Other systems, methods, features, and advantages of the present invention will be or become apparent to one with skill in the art upon examination of the following drawings and detailed description. It is intended that all such additional systems, methods, features, and advantages be included within this description and be within the scope of the disclosure.

### BRIEF DESCRIPTION OF THE DRAWINGS

Many aspects of the disclosed systems and methods can be better understood with reference to the following drawings. The components in the drawings are not necessarily to scale, emphasis instead being placed upon clearly illustrating the principles of the disclosed systems and methods. Moreover, in the drawings, like reference numerals designate corresponding parts throughout the several views.

FIG. 1A is an example web-based implementation for an embodiment of an absence management system.

FIG. 1B is an embodiment of the absence management system shown in FIG. 1A.

FIG. 2 is a schematic diagram of an embodiment of an example data import file used by the absence management system of FIG. 1B.

FIG. 3 is a flow diagram of an embodiment of an absence management method of the absence management system of FIG. 1B corresponding to leave designations under FMLA.

FIGS. 4A-4D are flow diagrams further illustrating the leave designation process illustrated in FIG. 3.

FIG. 5 is a flow diagram of an embodiment of an absence management method of the absence management system of FIG. 1B corresponding to leave administration or tracking.

FIG. 6 is a flow diagram further illustrating the leave administration process illustrated in FIG. 5 for leave request modifications.

FIGS. 7A-7B are flow diagrams further illustrating the leave administration process illustrated in FIG. 5 for status requests/certifications.

FIG. 8 is a flow diagram of an embodiment of an absence management method of the absence management system of FIG. 1B corresponding to return-to-work processing.

FIG. 9 is a flow diagram of an embodiment of an absence management method of the absence management system of FIG. 1B corresponding to terminating/not returning to work (non-federal medical leave act, or non-FMLA) decision processing.

FIG. 10 is a flow diagram of an embodiment of an absence management method of the absence management system of FIG. 1B corresponding to terminating/not returning to work (FMLA) decision processing.

FIGS. 11A-11B are flow diagrams of an embodiment of an absence management method of the absence management system of FIG. 1B corresponding to serious health condition decision processing.

FIG. 12A is a flow diagram of an embodiment of an absence management method of the absence management system of FIG. 1B corresponding to automatically-alerted fitness for duty (FMLA) decision processing.

FIG. 12B is a flow diagram of an embodiment of an absence management method of the absence management system of FIG. 1B corresponding to manually-alerted fitness for duty (FMLA) decision processing.

FIG. 13 is a flow diagram of an embodiment of an absence management method of the absence management system of FIG. 1B corresponding to fitness for duty (non-FMLA) decision processing.

FIG. 14 is a flow diagram of an embodiment of an absence management method of the absence management system of FIG. 1B corresponding to job restructuring/accommodation decision processing.

FIG. 15 is a flow diagram of an embodiment of an absence management method of the absence management system of FIG. 1B corresponding to reassignment/light-duty (FMLA) decision processing.

FIG. 16 is a flow diagram of an embodiment of an absence management method of the absence management system of FIG. 1B corresponding to reassignment/light-duty (non-FMLA) decision processing.

FIG. 17 is a flow diagram of an embodiment of an absence management method of the absence management system of FIG. 1B corresponding to key employee decision processing.

FIG. 18 is a flow diagram of an embodiment of an absence management method of the absence management system of FIG. 1B corresponding to leave extension decision processing.

FIG. 19 is a flow diagram of an embodiment of an absence management method of the absence management system of FIG. 1B corresponding to defining disability decision processing.

FIG. 20 is a screen diagram of an example login page of the absence management system shown in FIG. 1B.

FIG. 21A is a screen diagram of an example leave request form of the absence management system shown in FIG. 1B.

FIG. 21B is a screen diagram of an example leave request form of the absence management system shown in FIG. 1B for intermittent leaves.

FIG. 22A is a schematic diagram that illustrates automatic alert mechanisms of the absence management system shown in FIG. 1B.

FIG. 22B is a schematic diagram that illustrates automatic letter generation mechanisms of the absence management system shown in FIG. 1B.

FIG. 22C is a screen diagram of an example alert screen of the absence management system shown in FIG. 1B.

FIG. 23 is an example screen diagram of a leave requests page of the absence management system shown in FIG. 1B.

FIG. 24A is a screen diagram of an example entitlement/eligibility page of the absence management system shown in FIG. 1B.

FIG. 24B is a screen diagram of an example override designation page prompted from the entitlement/eligibility page shown in FIG. 24A.

FIG. 25A is a screen diagram of an example leave request summary page of the absence management system shown in FIG. 1B.

FIG. 25B is a screen diagram of an example summary details page prompted from the leave request summary page shown in FIG. 25A.

FIG. 25C illustrates an example e-mail page of the absence management system shown in FIG. 1B that can be used to send the case history of the employee.

FIG. 26 is a screen diagram of an example leave requests summary report page of the absence management system shown in FIG. 1B.

FIG. 27A is a schematic diagram that illustrates the notification letters provided by the absence management system shown in FIG. 1B.

FIG. 27B is a screen diagram of an example print letter screen of the absence management system shown in FIG. 1B.

FIGS. 28A-28E are screen diagrams that illustrate example decision processing web-pages for a terminating/not returning triggering event for an employee.

### DETAILED DESCRIPTION

Preferred embodiments of an absence management system are disclosed. An absence management system enables entry of employee leave requests, facilitates decisions on the designation of those requests, generates notifications of those decisions, tracks employee family medical leave act (FMLA) entitlement and eligibility, and provides record keeping and reporting of the requests, decisions, and/or communications.

An absence management system enables performance of the aforementioned functions through the provision of a plurality of web-interfaces (e.g., web-pages, screens, etc.), herein referred to as web-pages. The web-pages are preferably provided through the use of a web browser. Such interfaces can be provided to an administrator such as a payroll person operating under SAP, employee supervisors, leave managers, and/or system administrators. Although the web-pages may appear slightly different to an individual having one of the listed job titles (e.g., a web-page presented to a supervisor may have fewer functions than a similar functional page presented to a system administrator), the web-pages described herein will be addressed to an administrator with an understanding of similar page formats, functionality, and applicability to individuals with other job titles. Access to an absence management system may also be available to employees for some functions, such as entering a leave request as described below.

An administrator may interact with an absence management system to respond to new leave requests and events generated by the process of leave management (e.g., medical certification due dates and receipt acknowledgment, leave allocation expiration, return-to-work dates, etc.). Such responses may include computer-assisted decisions leading to leave designations and communication with employees through printed (or electronic) notices, and the closing of leave requests. An absence management system enables an administrator (with proper authorization) to view employee contact information, recall previous leave history, determine current eligibility, request status reports, run reports, and perform “what-if” decision tree analysis. Authorization to perform one or more of these functions may be provided by a system administrator or other responsible person who may perform these or other functions such as creating new user logins, assigning new passwords to a supervisor, or disabling a user from the system.

An absence management system also comprises functionality for decision processing (herein also referred to as decision tree processing, or similar terminology). Decision processing enables an administrator to process leave and/or return-to-work issues in a manner that meets federal and state regulations for such absence issues, as well as provide a system of reporting and fairness that may reduce the possibility of, or at least improve an employers' chances of success in, any subsequent employer-employee litigation.

An absence management system also provides for the generation of notifications to employees, for example as hard-copy letters (or electronic copies), and also provides for alerts to an administrator corresponding to various milestone events in the leave administration process. Further functionality of the absence management system includes the generation of reports.

An overview of an example network is provided in which an absence management system can be implemented, followed by some flow diagrams that illustrate some absence management features and methods employed by an absence management system for leave designation, tracking, and return-to-work issues. Example web-pages and schematic diagrams are then provided to illustrate the interaction between an administrator and an absence management system.

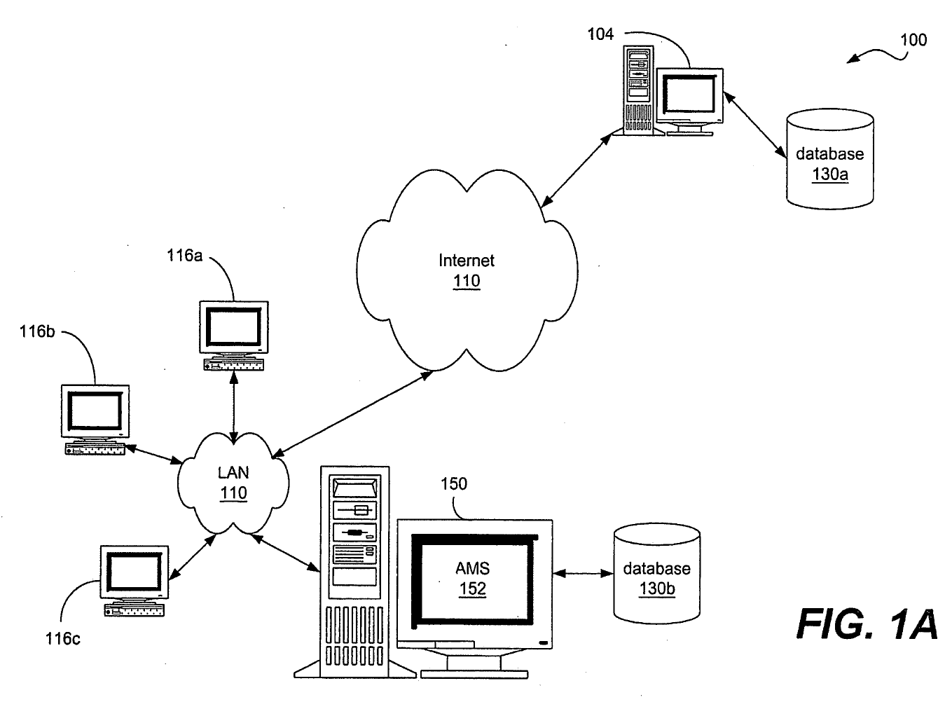

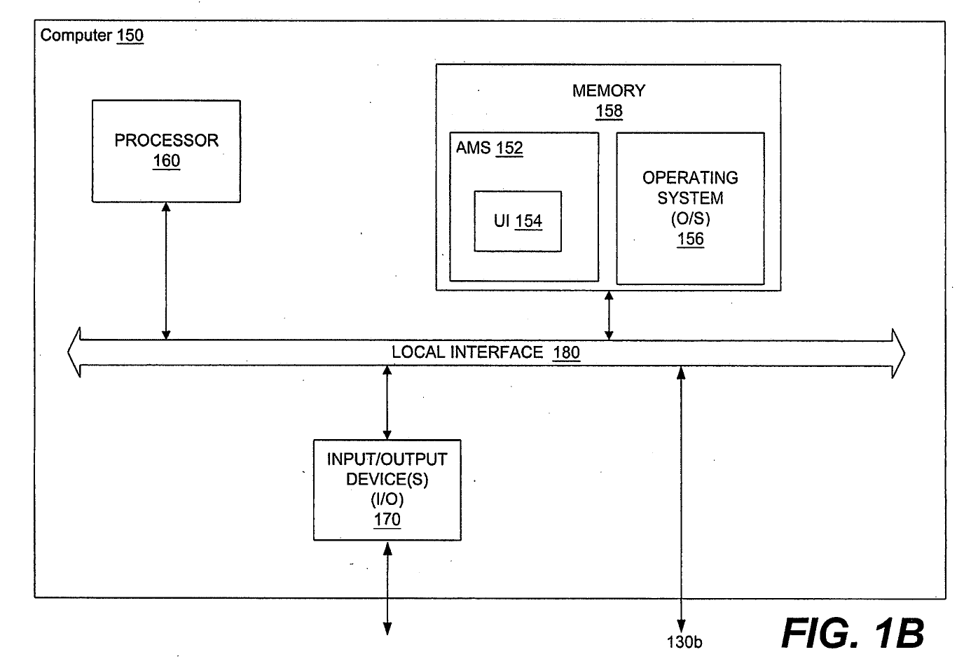

FIG. 1A is a block diagram depicting an example network infrastructure 100 for implementing an embodiment of an absence management system (AMS) 152. The example network infrastructure 100 includes one or more local area networks (LANs) 110 that support a plurality of workstations 116a-c, which are served by one or more LAN servers or computers 150 that include one or more accompanying databases 130b internal or external to the LAN server 150. The LAN server 150 can be coupled to the Internet 110, with or without an intermediary Internet Service Provider (not shown), as is true for other components shown. As is well known to those skilled in the art, the Internet 110 comprises and is coupled to a host of other networks (e.g., LANs, wide area networks, regional area networks, etc.) and users. A central server 104 can be provided, which includes, or is in communication with one or more associated central databases 13oa, and is also coupled to the Internet 110, among other networks not shown.

In one embodiment, the absence management system 152 is configured as software embodied in a LAN server 150. The LAN server 150 can support the workstations 116a-c, which, for example, access the LAN server 150 and database 130b via browser software at each workstation, according to well-known mechanisms.

Further, the mechanisms by which the workstations 116a-c access the LAN server 150 (or the LAN server 150 accesses the central server 104) include CGI (Common Gateway Interface), ASP (Application Service Provider) and Java, among others. In some embodiments, the absence management system 152 can be maintained at the central server 104, and thus accessed by the LAN server 150 using browser software as described above. Updates to the absence management system 152 can be implemented via downloads from the central server 104, among other mechanisms. In some embodiments, the functionality of the absence management system 152 can be distributed between the LAN server 150 and the central server 104.

One skilled in the art will also understand that the various databases, such as database 130b, can be stored on a digital video disc (DVD) or other storage medium, run from the workstations 116a-c, LAN server 150, etc. Further, one skilled in the art would understand that communication among the various components in the example network infrastructure 100 can be provided using one or more of a plurality of transmission mediums (e.g., Ethernet, T1, hybrid fiber/coax, etc.) and protocols (e.g., via HTTP and/or FTP, etc.).

FIG. 1B is a block diagram of the example LAN server 150 that, in one embodiment, can implement the absence management system 152. With continued reference to FIG. 1A, one skilled in the art will understand that the example LAN server 150 can be embodied as one or more of the workstations 116a-c and/or central server 104 of the example network infrastructure 100, alone or in combination (i.e., in a single component, or distributed over several components in the example network infrastructure 100), among other embodiments. Further, one skilled in the art will understand that additional components or different components with similar functionality can be included in the LAN server 150, and/or some components can be omitted, in some embodiments. The absence management system 152 can be implemented in software, as an executable program, and can be executed by a special or general purpose digital computer, such as a personal computer (PC; IBM-compatible, Apple-compatible, or otherwise), workstation, minicomputer, or mainframe computer. The absence management system 152 includes a user-interface (UI) module 154 that provides display functions (e.g., web-pages) according to well-known web-page or screen display generation and formatting mechanisms.

Generally, in terms of hardware architecture, as shown in FIG. 1B, the LAN server 150 includes a processor 160, memory 158, and one or more input and/or output (I/O) devices 170 (or peripherals) that are communicatively coupled via a local interface 180. The local interface 180 can be, for example, one or more buses or other wired or wireless connections. The local interface 180 may have additional elements (not shown) to enable communications, such as controllers, buffers (caches), drivers, repeaters, and receivers. Further, the local interface 180 may include address, control, and/or data connections to enable appropriate communications among the aforementioned components. The absence management system 152 can also communicate with the database 130b via the local interface 180. The local database 130b can be external to or integral to the LAN server 150.

The processor 160 is a hardware device capable of executing software, particularly that stored in memory 158. The processor 160 can be any custom made or commercially available processor, a central processing unit (CPU), an auxiliary processor among several processors associated with the LAN server 150, a semiconductor based microprocessor (in the form of a microchip or chip set), a macroprocessor, or generally any device for executing software instructions.

Memory 158 can include any one or combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory 158 may incorporate electronic, magnetic, optical, and/or other types of storage media. Note that memory 158 can have a distributed architecture, where various components are situated remote from one another, but can be accessed by the processor 160.

The software in memory 158 may include one or more separate programs, each of which comprises an ordered listing of executable instructions for implementing logical functions. In the example LAN server 150 of FIG. 1B, the software in the memory 158 includes the absence management system 152 and a suitable operating system (O/S) 156. In one embodiment, the LAN server 150 and corresponding database 130b can be implemented using Linux 2.4.19 or higher, a Resin 2.x XML/Java Application Server, and a mySQL database. One or more of the web-based pages described below can run on Microsoft windows 98 or greater, Internet Explorer 5.5 or greater, and/or a browser compatible with Netscape 4.7 or greater (or Internet Explorer 5.0 or greater). Printing functions may use a printer-set-up such as Microsoft Windows, and e-mail functionality can be provided through Sendmail (e.g., using Sendmail 8.x).

The operating system 156 essentially controls the execution of other computer programs, such as the absence management system 152, and provides scheduling, input-output control, file and data management, memory management, and communication control and related services.

The absence management system 152 can be a source program, executable program (object code), script, and/or any other entity comprising a set of instructions to be performed. When a source program, then the program may be translated via a compiler, assembler, interpreter, or the like, which may or may not be included within memory 158, so as to operate properly in connection with the operating system 156. Furthermore, the absence management system 152 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, ASP, and Ada.

The I/O devices 170 may include input devices, such as a keyboard, mouse, scanner, microphone, etc. Furthermore, the I/O devices 170 may also include output devices, such as a printer, display, etc. Finally, the I/O devices 170 may further include devices that communicate both inputs and outputs, for instance a modulator/demodulator (modem; for accessing another device, system, or network), a radio frequency (RF) or other transceiver, a telephonic interface, a bridge, a router, etc.

When the LAN server 150 is in operation, the processor 160 is configured to execute software stored within memory 158, to communicate data to and from memory 158, and to generally control operations of the LAN server 150 pursuant to the software. The absence management system 152 and the operating system 156, in whole or in part, but typically the latter, are read by the processor 160, perhaps buffered within the processor 160, and then executed.

When the absence management system 152 is implemented in software, as is shown in FIG. 1B, the absence management system 152 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The absence management system 152 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In one implementation, the absence management system 152 may cooperate with an organization's payroll system (not shown). For example, payroll is preferably interfaced through a batch file upload run at some specified period. This can be a one-way transfer of employee data from the payroll system to the absence management system 152 through an FTP transfer of the specified file format. A response to the payroll system may be a standard FTP successful acceptance response. Alerts can be generated to an administrator to indicate success or failure of processing the batch. Processing of the batch may include adding employee demographic and/or employment status records to a database (e.g., database 130b of FIG. 1A), updating addresses, and/or updating hours worked per week per employee. The absence management system 152 can use this data to determine eligibility based on tenure, and/or to determine the destination for notification letters, among other functions. Thus, a payroll system can be the “database of authority” for employee information, such that manual entry or modification to that information within the structures of FMLA can be overridden by the next payroll batch process.

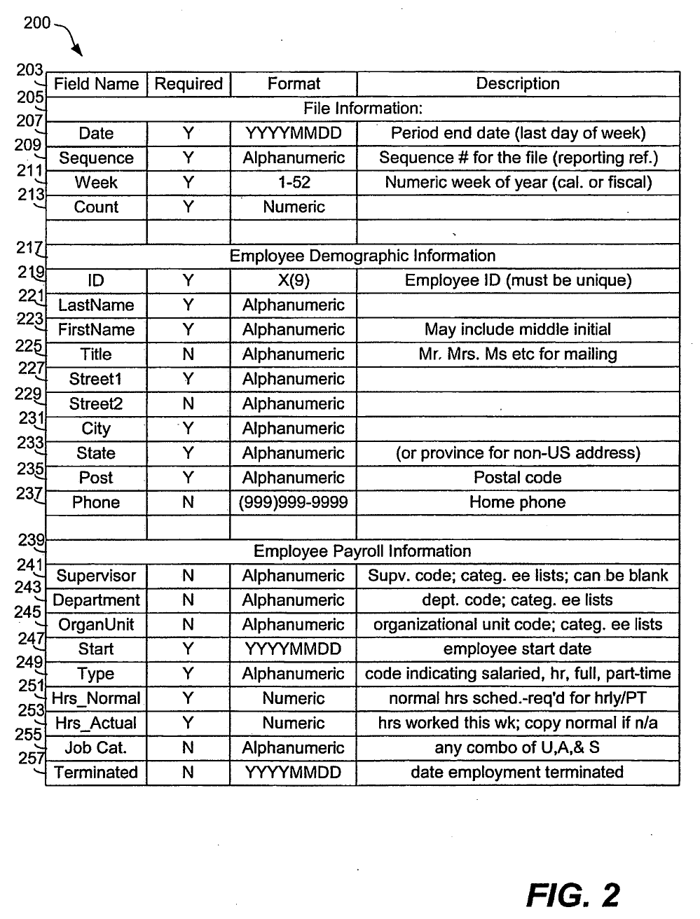

FIG. 2 is a schematic diagram illustrating an example import file 200 that may be used, in whole or in part, in the absence management system 152 (FIG. 1B). As indicated above, the import file 200 may be delivered from a payroll system or other source of employee data and refreshed periodically (e.g., weekly). The content of the import file 200 may be determined based on discussions between the vendor for the absence management system 152 and an employer that will utilize the functionality of the absence management system 152. The data import file 200 includes information that is basic to making FMLA designations. In some embodiments, additional information may be added to the import file 200 (e.g., whether a particular employee belongs to a union or not) and/or some information may be omitted or altered. The data import file 200 may include one record per employee, with the fields listed as shown. Each data import file 200 is preferably used to create an employee record in the absence management system database (e.g., database 130b, FIG. 1A) if that employee is not already recorded therein. Otherwise, the data import file 200 can be used to update the existing record. The data import file 200 is preferably configured in a tab-delimited format.

Each data import file 200 preferably begins with a header record (not shown) identifying the file and a trailer record (not shown) including the record count. As some fields are indicated as required, these fields need only be supplied for first-time import or when they change, with the exception of the employee ID number, last name, and hours worked. The data import file 200 includes several columns, as illustrated in line 203. These columns include field name, whether a field corresponding to the field name is required, format, and description. Further sections are delineated by a file information section as indicated by line 205, employee demographic information section as indicated by line 217, and employee payroll information section as indicated by line 239. The file information section includes field names of date 207, sequence 209, week 211, and count 213. The date field of line 207 is required as indicated by “Y” in the “required” column, has a format of year, month and date (YYYYMMDD) as indicated in the “format” column, and is described as the period and date (last day of the week) as indicated in the “description” column. The sequence field, as indicated in line 209, is a required field as indicated by the “Y,” has an alphanumeric format, and is described as providing an indication of the sequence number for the file (reporting reference). The week field name corresponding to line 211 is also a required field name, and has a format of 1-52 corresponding to the numeric weeks of the year (e.g., either calendar or fiscal year). The field name count, corresponding to line 213, is a required field, and has a numeric format.

The employee demographic information section, as indicated by line 217, includes an ID field line 219, LastName field line 221, FirstName field line 223, title field 225, street1 field 227, street2 field 229, city field 231, state field 233, post field 235, and phone field 237. The ID field 219 is a required field as indicated by the “Y” in the required column, has a 9-digit format, and corresponds to the employee identification (ID), which is preferably unique. The LastName field 221 is a required field (Y), and is an alphanumeric format. The FirstName field 223 is a required field, and is an alphanumeric format, and may include the middle initial. The title field 225 is not a required field (e.g., as shown by the “N” in the “required” column), is an alphanumeric field, and may include such salutations as Mr., Mrs., Miss, etc. for mailing. The street1 field 227 is a required field and has an alphanumeric format. The street2 field 229 is not a required field, but has an alphanumeric format. The city field 231 is a required field that has an alphanumeric format. The state field 233 is a required field that has an alphanumeric format and can include a province for non-U.S. addresses. The post field 235 is a required field that has an alphanumeric format and is used as the postal code. The phone field 237 is not a required format, has a format of (area code, 999) 999-9999, and is used to describe the home phone number.

The employee payroll information corresponding to line 239 has a supervisor field 241, department field 243, organizational unit field 245, start field 247, type field 249, hours_normal field 251, hours_actual field 253, job category field 255, and terminated field 257. The supervisor field 241 corresponds to the supervisor code which is used to categorize employee lists. This field is not required and can be blank, but if used, uses an alphanumeric format. The department field 243 is not a required field and uses an alphanumeric format, and corresponds to the department code to be used to categorize employee lists. The organization unit field 245 is also used to categorize employee lists, but is not a required field, and uses an alphanumeric format. The start field 247 corresponds to the employee start date, is a required field, and has a format of year, month and date. The type field 249 is a required field, uses an alphanumeric format, and is a code indicating salaried, hourly, full-time, and/or part-time employees. The hours_normal field 251 is also a required field that uses a numeric format, and is used for normal hours scheduling (which may be required for hourly and part-time employees). The hours_actual field 253 is a required field that uses a numeric format. This field 253 corresponds to the hours worked in a particular week, and can be copied from the normal hours field 251 when not available (e.g., salaried employees). The job category field 255 is not a required field, uses an alphanumeric format, and can be any combination of union (U), administrative (A), and support staff (S), respectively. The terminated field 257 is not a required field, has a format of year, month, and date, and is used to indicate when the employment was terminated.

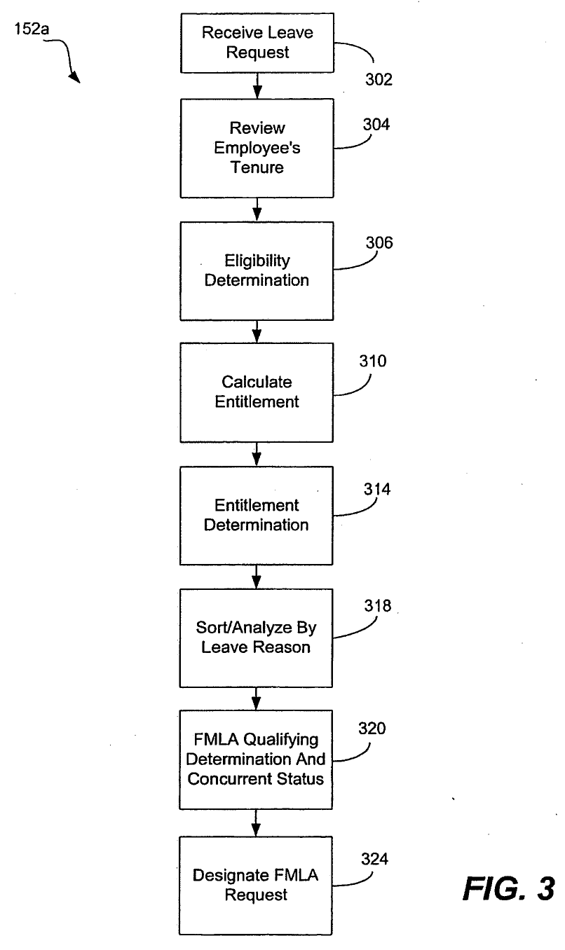

The absence management system 152 is a centric leave administration system designed to assist employers in managing the leave and attendance of employees with medical related absences. FIGS. 3 through 19 are flow diagrams that illustrate methods employed by the absence management system 152. The methods shown in these diagrams can generally be categorized as FMLA designation, tracking or administration of leaves, and return-to-work compliance administration. Any process descriptions or blocks in flow charts should be understood as representing modules, segments, or portions of code which include one or more executable instructions for implementing specific logical functions or steps in the process. Alternate implementations are included within the scope of the preferred embodiments in which functions may be executed out of order from that shown or discussed, including substantially concurrently or in reverse order, depending on the functionality involved, as would be understood by those reasonably skilled in the art.

FIG. 3 is a flow diagram of an embodiment of an absence management method 152a that provides an illustration of how leave designations are handled by the absence management system 152 (FIG. 1B). Block 302 includes receiving a leave request. The leave request includes employee information that has been populated using information from the data import file 200 (FIG. 2). In block 304, the employee's tenure (e.g., hours worked, etc.) is reviewed, and from this information a FMLA eligibility determination is made in block 306. Block 310 includes calculating the employee's entitlement, and a determination about entitlement is made in block 314. The absence management method 152a automatically makes eligibility and entitlement determinations, designations for concurrent administrations (e.g., worker's compensation, ESL/STD and maternity leaves), and provisional designations. Leave requests are sorted and analyzed by leave reason in block 318 to determine whether the leave is FMLA qualifying and the concurrent status. Based on these aforementioned determinations and calculations, a FMLA qualifying determination is made in block 320. Assuming a successful qualifying determination, the leave is designated as a FMLA request in block 324.

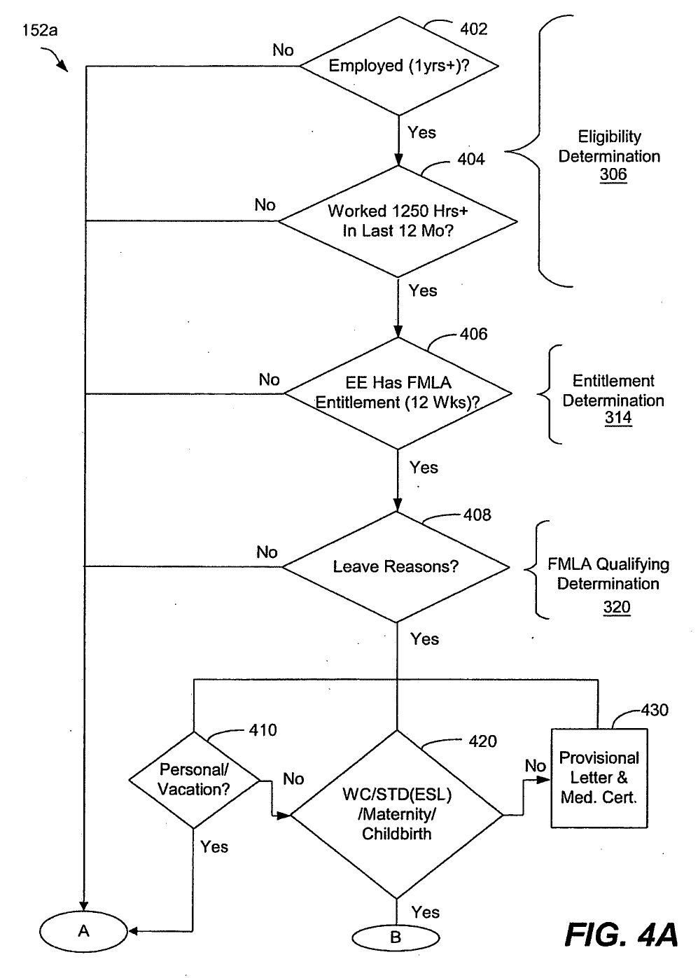

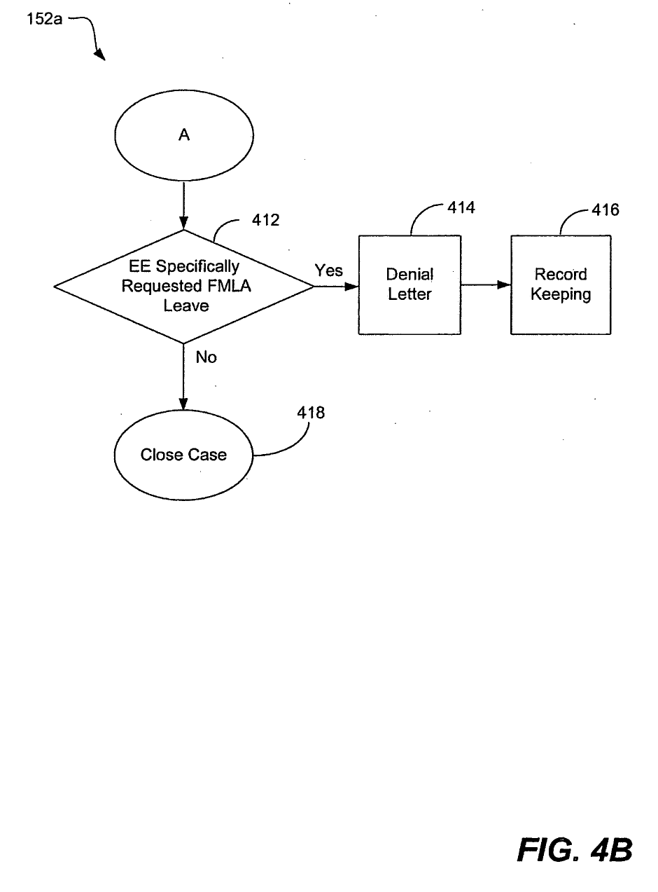

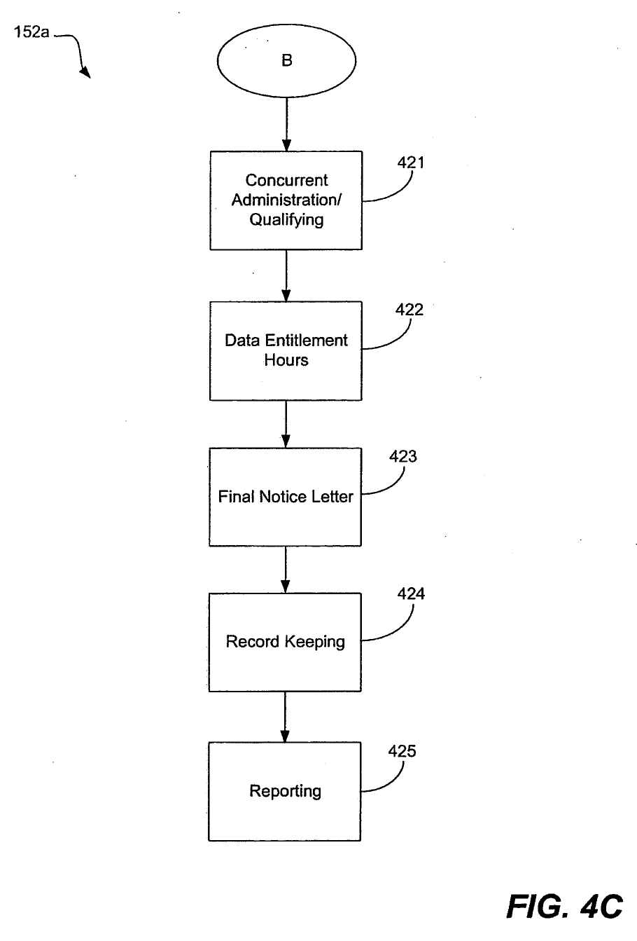

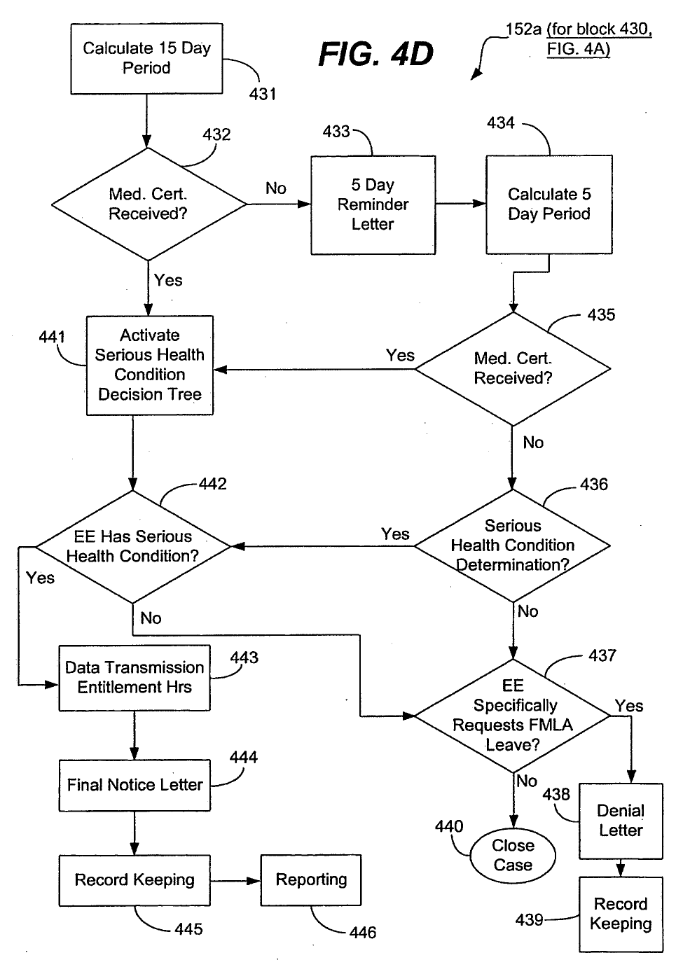

FIGS. 4A through 4D further illustrate various processing in the absence management method 152a described in association with FIG. 3, in particular the eligibility determination (block 306), entitlement determination (block 314), and the FMLA qualifying determination (block 320). The absence management method 152a includes receiving a leave request, and responsively, acquiring data to make a plurality of calculations and determinations. Under FMLA, eligibility and entitlement determinations are primarily based on processing data sourced from the data import file 200 (FIG. 2) of a particular employee. Information in the data import file 200 pertinent to FMLA includes whether an employee has worked 1,250 hours in the present year, and whether the employee has entitlement remaining. Additional information of interest to FMLA determinations includes whether the employee has used twelve weeks of leave in a 1-year period. The determination of a 1-year period may be based on several accounting methods, such as a “rolling-backwards method,” among others. Additionally, FMLA leave determinations include whether the employee has 12 weeks (based on the employee workweek schedule) remaining in his or her leave entitlement. The calculations and determinations of the absence management method 152a are based on an implementation complying with federal statutory rules for FMLA. Thus, qualifying reasons will also enter into the determinations, such as the employee's own sickness, family member sickness, child adoption, among others. The absence management method 152a also addresses whether short-term disability or worker's compensation is being provided to the employee. For example, under federal statutes, an employee can run disability programs concurrently with FMLA.

Although described using an implementation under federal statutes, the absence management system 152 can be configured to operate under state family medical leave laws as well. For example, where the state's family medical leave law is more generous than the federal statutes, such as the case in California, FMLA leave and disability are not allowed to run concurrently. In such circumstances, the federal statute says that if state law is more generous, then operation for leave will be under state law.

Referring to FIG. 4A, the absence management method 152a includes making an eligibility determination 306 by determining whether an employee has been employed for one year or more (block 402), and determining whether the employee has worked 1,250 hours or more in the last twelve months (block 404). If the employee has been employed for one year or more (block 402), block 404 includes determining whether the employee has worked 1,250 hours or more in the last twelve months. If so, an entitlement determination (block 314) is performed. If the employee has not been employed for one year or more (block 402), or if the employee has not worked for 1,250 hours or more in the last twelve months (block 404), then processing continues at block A, as described below. For entitlement determinations (block 314), block 406 includes determining whether an employee has FMLA entitlement (12 weeks). If not, processing continues at block A, otherwise block 320 includes making a FMLA qualifying determination. Under the FMLA qualifying determination (block 320), block 408 includes determining the reason(s) for the leave. If there are no documented reasons for the leave, processing continues at block A. If the reason for the leave is for personal reasons or vacation (block 410), then processing continues at block A. Otherwise, block 420 includes determining whether the reason for the leave is due to worker's compensation, short term disability, extended leave, maternity leave, or child birth. If for one of these reasons, processing continues to block B. Otherwise, block 430 includes providing a provisional letter and medical certification.

FIG. 4B is a flow diagram that illustrates processing of a leave request proceeding from block A of FIG. 4A. Block 412 includes determining if the employee specifically requested FMLA leave. If not, the case is closed in block 418. In other words, the absence management method 152a closes the case for designation purposes and the administrator receives an alert that the case is non-FMLA if it remains open for tracking purposes. If the employee specifically requested FMLA leave (block 412), then block 414 includes generating a denial letter, and block 416 includes recording the generation of a denial letter and circumstances prompting its generation.

FIG. 4C is a flow diagram that illustrates processing from block B of FIG. 4A. In block 421, a concurrent administration/qualifying determination is made (e.g., worker's compensation, short term disability, etc.). In block 422, the entitlement hours are determined, and in block 423, a final notice letter is generated. Block 424 includes recording the generation of the letter and corresponding circumstances, and in block 425, the same is reported. As used herein, the documentation of actions are “recorded” in an employee's leave history and “reported” in a summary report.

FIG. 4D is a flow diagram that further illustrates block 430 (FIG. 4A) for the absence management method 152a, which includes providing a provisional letter. For all provisionally designated FMLA leaves, the absence management method 152a generates employee notification letters regarding the provision of medical certification. An administrator may respond to a medical certification alert by indicating that the certification has been received. The designation process should proceed without it if the serious health condition decision tree is activated (where the administrator is lead through the determination of whether the leave should be designated as FMLA qualifying by means of a series of Yes or No inquiries, as explained below). With regard to provisionally designated leaves and provisional letters, an employer has a short period of time (e.g., 2-3 days) once the employee provides notice of the need for leave to advise the employee of his or her FMLA rights. Therefore, in situations where additional information is needed to determine whether the employee has a serious health condition, a provisional designation is made until the medical certification is returned. Block 431 includes calculating a fifteen-day period. By statute, the employee is entitled to 15 days to return the medical certification. The employer has the choice regarding whether to send a reminder and the time-frames related to the reminder. Block 432 includes determining whether a medical certification has been received. If not, block 433 includes generating a five-day reminder letter, and block 434 includes calculating a five-day period. Block 435 includes determining whether a medical certification has been received. If not, block 436 includes determining whether there is a serious health condition determination. If not, block 437 includes determining whether the employee has specifically requested FMLA leave. If so, a denial letter is generated in block 438, and a record of this generation of the denial letter and the circumstances surrounding the generation of the letter are recorded in block 439. If the employee did not specifically request FMLA leave (block 437), block 440 includes closing the case.

Referring to block 432, if the medical certification was received, block 441 includes activating the “serious health condition” decision tree. Also, if the medical certification was received in block 435, processing continues to block 441. In block 442, a determination is made whether the employee has a serious health condition. Processing at block 442 also proceeds from block 436 if there is a determination that a serious health condition exists. If the employee does not have a serious health condition (block 442), then processing continues to block 437. If the employee does have a serious health condition (block 442), block 443 includes transmitting the entitlement hours, and a final notice letter is generated in block 444. With regard to transmitting, the absence management method 152a gathers the entitlement data in preparation for tracking the leave. At that point, the system is moving from the designation process to the tracking process. Further, the generation of the final notice letter and the circumstances surrounding this event are recorded (block 445) and reported (block 446).

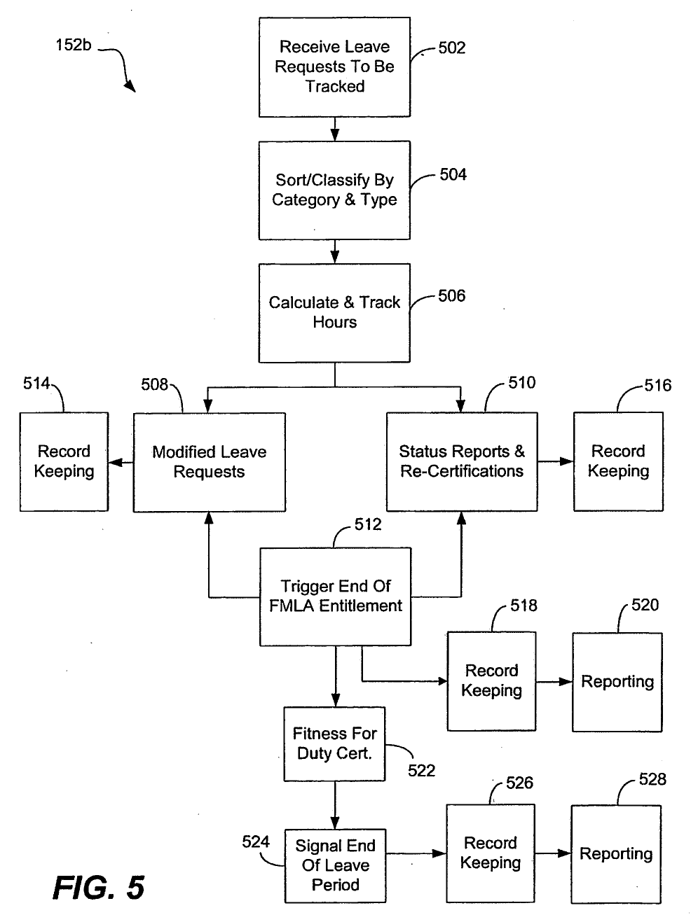

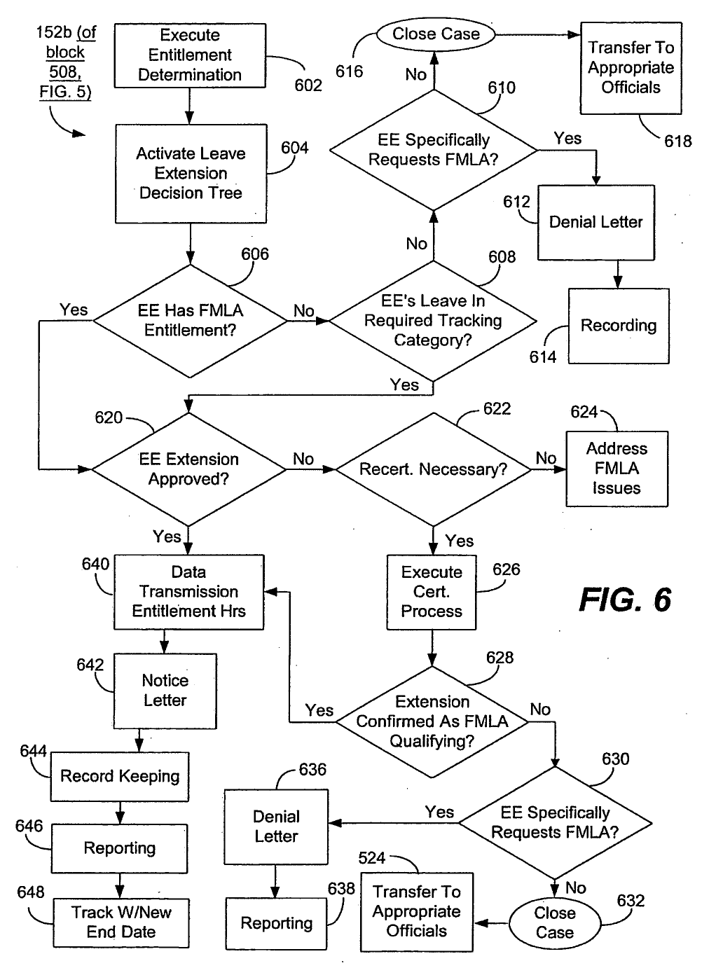

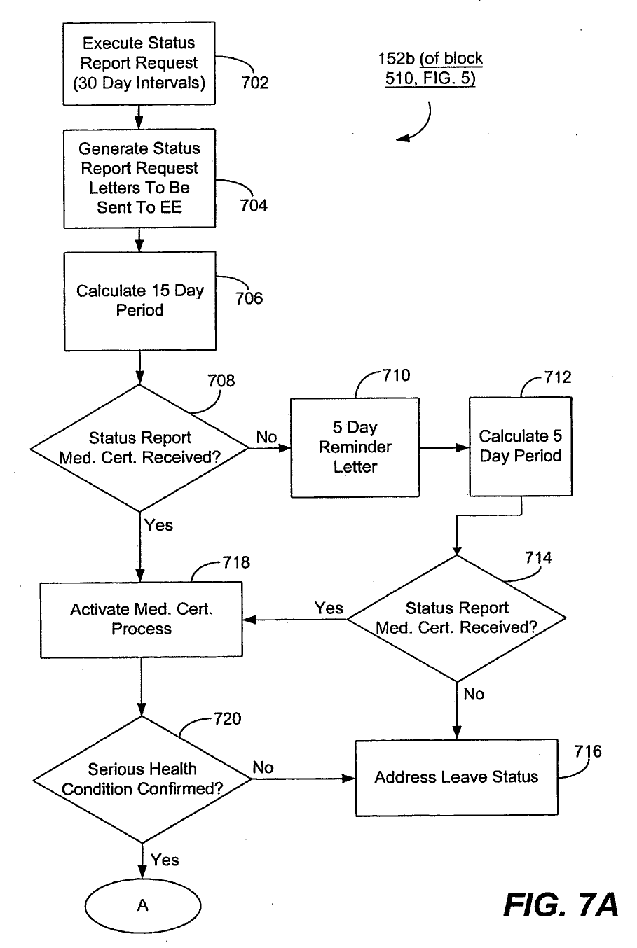

FIGS. 5-7B are flow diagrams that illustrate the tracking or administration of leaves in selected categories (e.g., FMLA, worker's compensation, ESL/STD, maternity leaves). The absence management system 152 (FIG. 1B) automatically tracks the employee's leave from the start date to the recorded end date, with modifications to the initial leave request influencing operation. In particular, the absence management system 152 calculates and maintains an employee's FMLA entitlement. Automatic alerts and/or letters are generated during the administration or tracking of the leave. Such alerts and letters are typically triggered when the employee has depleted his/her FMLA entitlement. In other words, the absence management system 152 includes prompts for all required actions in the form of alerts regarding new requests, reminders (pending actions), and leave request changes. In addition, a record of documentation sought (e.g., medical certification, fitness for duty certification) regarding the employee's leave is also maintained. For example, letters related to FMLA designation and tracking are automatically triggered. Reminders are generated for an administrator to investigate employee notification. The absence management system 152 also generates letters and forms that the administrator can, for example, manually activate from a letter selection icon in a leave request menu (not shown). The absence management system 152 also provides for directed e-mails, which may be generated automatically or manually. The directed e-mails may be generated for decision tree processing. An administrator may also send the case history by e-mail. If there is a dispute regarding eligibility, entitlement, or designation of an employee's leave request under FMLA, the administrator may indicate this dispute in the leave request. Concerning reporting, leave summary reports may be generated for a designated date span for the entire work force or by department.

Referring to FIG. 5, an embodiment of an absence management method 152b is illustrated. Block 502 includes receiving a leave request to be tracked. Block 504 includes sorting and/or classifying a leave request by category and type. Block 506 includes calculating and tracking the hours corresponding to the leave request. For a modified leave request (block 508), a record is maintained in block 514. Similarly, for status reports and re-certifications (block 510), a record is maintained in block 516. The modified leave request and status reports and re-certifications may trigger the end of FMLA entitlement (block 512). Blocks 506-512 reflect a leave administration aspect of the absence management method 152b, which includes operations that occur while an employee is out on leave (e.g., hours of leave taken are deducted from the appropriate leave bank, status reports of the employee's condition are requested, the employee's request of modifications of the original leave request are received and processed, notification of the end of FMLA entitlement, etc.). At a triggering event corresponding to an end of FMLA entitlement (block 512), a record of this event is maintained (block 518) and reported (block 520). In block 522, a fitness for duty certification is generated in response to the triggering event (in block 512), and the fitness for duty certification (block 522) signals or indicates an end of the leave period (block 524). In other words, automatic processing takes place, where an employer requires employees to submit a fitness for duty certification before returning to work. Under such circumstances, the absence management method 152b automatically produces a reminder letter prior to the end of the leave period (e.g., 5 days, employer's choice, etc.) advising the employee of the need to submit the certification. The fitness for duty certification (block 524) is recorded in block 526 and reported in block 528.

FIG. 6 is a flow diagram that further illustrates processing for block 508 of FIG. 5 by the absence management method 152b, which corresponds to the processing for a request for extension or change in leave type. Block 602 includes executing an entitlement determination. Block 604 includes activating a leave extension decision tree. Based on the decision tree processing in block 604, block 606 includes determining whether the employee has FMLA entitlement. If not, block 608 includes determining if the employee's leave is in the required tracking category. If not, block 610 includes determining if the employees specifically requested FMLA designation for his or her leave request. If so, a denial letter is generated in block 612, and circumstances of the generation of that letter and the letter itself are recorded in block 614. If the employee did not specifically request FMLA designation for his or her leave (block 610), the case is closed in block 616, and the case is transferred to an appropriate official in block 618. The closure of the case for designation purposes is automatic. The transfer may occur via administrator action, or in some embodiments, via an automatic directed e-mail.

Block 620 includes determining whether the employee extension is approved. Block 620 is a result of either an employee having FMLA entitlement as determined in block 606, or is due to the employee's leave being in a required tracking category (block 608). If the employee's extension is not approved (block 620), block 622 includes determining if re-certification is necessary. If re-certification is not necessary, block 624 includes prompting a discussion on addressing FMLA issues. In other words, an administrator may manually initiate a discussion based upon his or her assessment of potential FMLA issues. If re-certification is necessary (block 622), block 626 includes executing a certification process. Execution of the certification process may be activated by an administrator based upon the circumstances, or in some embodiments, the absence management method 152b may automatically generate a re-certification prompt for some or all leave extension requests. Once the re-certification process is activated, the absence management method 152b automatically generates the necessary letter and documents. Block 628 includes determining if the extension is confirmed as a FMLA qualifying event. If it is not a qualifying event, block 630 includes determining whether the employee specifically requested FMLA. If not, block 632 includes closing the case, and block 634 includes transferring the case to appropriate officials. If the employee specifically requested FMLA in block 630, a denial letter is generated in block 636 and the event is reported in block 638. If the employee extension is approved in block 620 or the extension is confirmed as a FMLA qualifying event in block 628, data transmission of entitlement hours occurs in block 640, and the notice letter is generated in block 642. The generation of the notice letter and circumstances surrounding that event are recorded in block 644, reported in block 646, and tracking begins with a new end date in block 648.

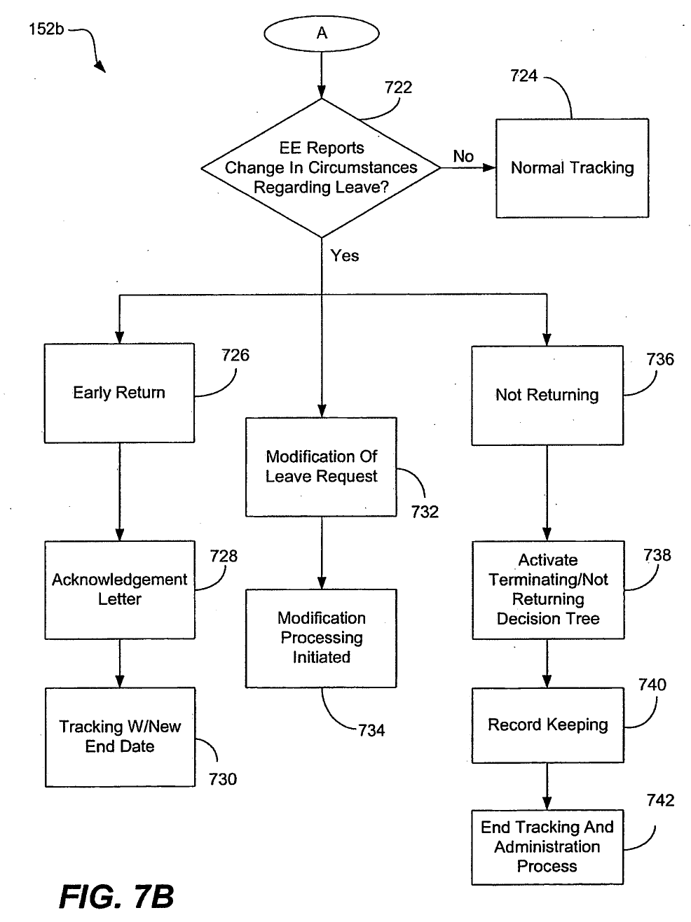

FIGS. 7A-7B further illustrate processing of block 510 of FIG. 5 by the absence management method 152b, which provides for processing of status reports and re-certifications. Referring to FIG. 7A, block 702 includes executing a status report request. For example, such an execution may occur in 30-day intervals, among other configured intervals. Block 704 includes generating a status report request letter or letters to be sent to the employee. The administrator, in one implementation, manually prints out and mails the letters. Block 706 includes calculating a 15-day period. Block 708 includes determining whether a status report for a medical certification is received. If not, block 710 includes generating a 5-day reminder letter, block 712 includes calculating a 5-day period, and block 714 includes determining whether a status report for a medical certification is received. If status report for a medical certification is not received, block 716 includes addressing the leave status. In other words, the administrator may be prompted by the absence management system 152 (FIG. 1B) to contact the appropriate managers to determine whether the employee can remain in leave status, and if so, whether there needs to be a change in leave category and/or FMLA designation. Block 718 includes activating the medical certification process (in response to a determination that a status report was received in block 708 or block 714). Block 720 includes determining if a serious health condition has been confirmed. If not, block 716 includes addressing the leave status. Otherwise, processing continues to block A.

In FIG. 7B, continuing from block A, block 722 includes determining whether the employee has reported a change in circumstances regarding the leave. If not, normal tracking continues in block 724. If the employee has reported a change in circumstance regarding the leave (block 722), then the change in circumstance may be an early return (block 726), a modification of the leave request (block 732), or a circumstance where the employee is not returning to work (block 736). If the circumstance is an early return (block 726), block 728 includes generating an acknowledgment letter, and block 730 includes tracking with a new end date. If the change in circumstance is a modification of the leave request (block 732), then modification processing is initiated in block 734. If the change in circumstances is that the employee is not returning to work (block 736), block 738 includes activating the terminating/not returning decision tree processing, which is recorded (in block 740), and tracking and administration ends at the end of the decision tree in block 742 (and the employee is terminated). In other words, once the employee indicates a desire not to return, the administrator is prompted to confirm and document (via the decision tree) and at the completion of that process, the tracking and administration process ends.

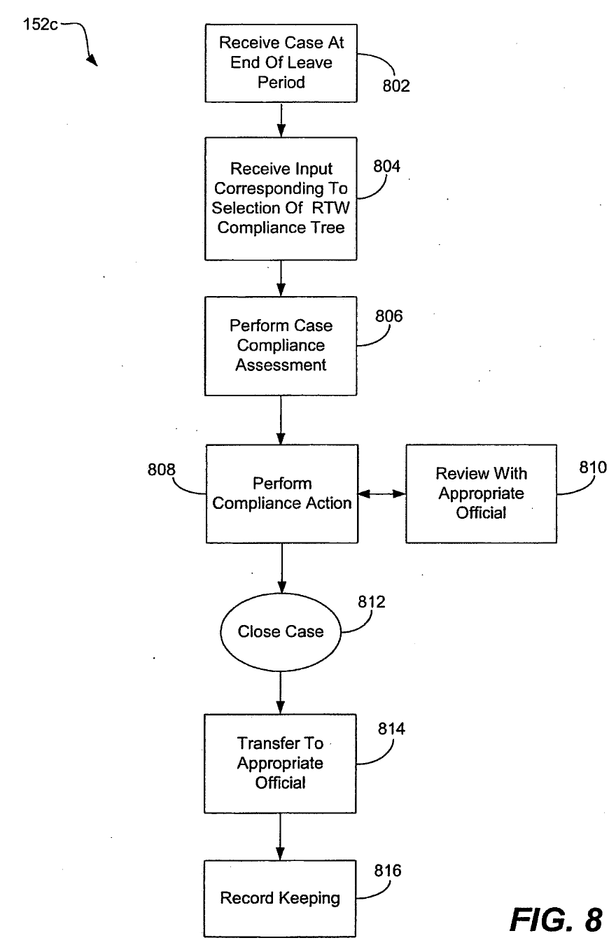

FIGS. 8-19 are flow diagrams that illustrate return-to-work compliance assessment methods that are employed by the absence management system 152 (FIG. 1B). For example, at the end of tracking, the absence management system 152 generates an alert to an administrator to initiate return-to-work processing. Note that return-to-work processing and decision trees that allow for this processing are not limited to post administration. The prompting of a decision tree web page can occur during administration or tracking. Options available include receiving a new request or closing the employee's leave by selecting an appropriate return-to-work option and navigating the corresponding decision tree. The decision trees may function as directed-guidance to assist an administrator in addressing compliance issues related to the employee returning to work. Resolution options such as referral to other departments, letters to the employee, and directed e-mails requesting input from relevant officials are presented. In one embodiment, the case resolution options correspond to the employer's leave and attendance policies and procedures.

FIG. 8 is a flow diagram that illustrates an embodiment of an absence management method 152c that provides for return-to-work decision processing. Block 802 includes automatically receiving a case at the end of a leave period. Block 804 includes receiving an input to select a return-to-work compliance tree. Block 806 includes performing a case compliance assessment in cooperation with an administrator. Block 808 includes performing a compliance action in cooperation with an administrator and in response to the compliance assessment, and block 810 includes reviewing the compliance action with an appropriate official. Block 812 includes automatically closing the case. In block 814, the case is transferred to an appropriate official, and in block 816, a record is made of this event. In blocks 804, 810, and 814 where cooperation with an administrator of the absence management system 152 (FIG. 1B) occurs, the administrator is prompted to take action by the absence management system 152.

The absence management system 152 (FIG. 1B) may process return-to-work issues corresponding to blocks 806 and 808 (FIG. 8) by considering several issues. In general, a triggering event initiates the decision tree process. Triggering events include changes in employee work status, such as reassignment/light-duty, job restructuring/modifications, termination not returning, and fitness for duty. Once the triggering event occurs, statutory mandates and/or employer policies/procedures are considered and used in the decision processing. Statutory mandates include state and federal family leave, ADA, Worker's Compensation, ERISA, OSHA, and HIPAA (a federal statute that addresses the confidentiality of medical data and information. The employer policies/procedures include STD/LTD programs, sick leave, maternity leave, other paid leave, and LWOP (leave without pay). The result of these considerations are a resolution strategy that may include procedural reminders, legal alerts and check lists, decision making compliance tools, departmental alerts, and/or mandatory referrals.

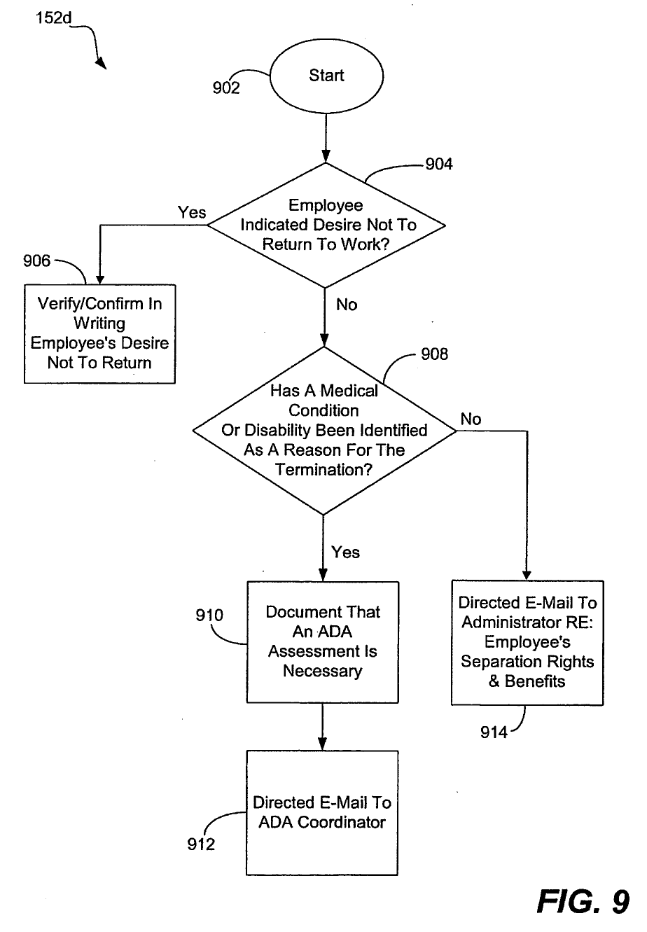

FIGS. 9-19 are flow diagrams that illustrate various decision tree methods employed by the absence management system 152 corresponding to the aforementioned triggering events. In particular, the decision trees preferably include the following: serious health condition (e.g., loaded upon confirmation of medical necessity), job restructuring/reassignment, job restoration, fitness for duty, termination/discipline, ADA accommodation, and conflict with Worker's Compensation, ADA, STD, or state regulations. These decision trees may be represented as a sequence of sub-trees, such that an intermediate decision places the overall decision in a paused or partially completed state. For example, the job restructuring tree “segment” would end (and be recorded in the leave request case) at the point where an administrator has determined that the employee has a documented disability. An action alert would preferably be set to indicate that the case was pending a requested accommodation decision, and that the alert would allow re-entry into the next segment of the job restructuring tree.

Before describing the flow diagrams of FIGS. 9-19, some underlying guidelines can be followed to facilitate decision processing. First, forced administrator response is preferably implemented only as part of the FMLA determination process (e.g., serious health condition and key employee determinations). Second, all other decision trees are directed-guidance. For example, based on administrator selection or response, the appropriate decision tree will appear to aid the compliance process. Third, the directed guidance decision trees are preferably activated by administrator selection from the following return-to-work options: (a) return-to-original position (no modifications), (b) termination/not-returning, (c) reassignment/light-duty, (d) job modification, (e) fitness for duty cert./evaluation, (f) request for leave extension, and (g) key employee. A key employee is a top-tier employee whose extended absence would cause grievous harm to a company, and thus whose FMLA rights are different (e.g., more limited) than other employees.

Each option except for return-to-original position has a corresponding decision tree. A selection of return-to-original position closes the leave period and ends processing with the proper notation. Fourth, to ensure that the administrator is not asked to supply data that is already in the system, the decision trees, where applicable, are divided by FMLA & non-FMLA leave status. Thus, the entry point for the tree incorporates processing that has already occurred within the system. Fifth, upon entering a tree, the administrator can proceed in one of two modes: informational (e.g., nothing is recorded) or case processing (e.g., decisions are recorded with respect to the leave period/case in question). Sixth, while stepping through one decision tree, the administrator may consult other decision trees in the informational mode. Seventh, if the administrator enters a directed guidance decision tree while the employee is still on leave and proceeds to begin case processing, the system preferably prompts the administrator to input information regarding a leave modification. Finally, the decision processing trees enable the administrator to manually create a case for return-to-work purposes even if the employee is not on leave or an FMLA designation is not operational.

FIG. 9 is a flow diagram that illustrates decision processing corresponding to terminating/not-returning (non-FMLA), according to an embodiment of an absence management method 152d. Proceeding from the start block 902, a query is made to decide if the employee has indicated a desire not to return to work (block 904). If the employee has indicated a desire (“yes”), the block 906 includes providing a verification/confirmation in writing documenting the employee's desire not to return to work. The absence management method 152d prompts the administrator to answer a series of questions that reflect the documentation that the employer wishes to maintain, and the answers are retained as part of the case history within the system (i.e., “documenting”). Otherwise, a “no” response to block 904 results in a determination in block 908 as to whether a medical condition or disability has been identified as a reason for the termination. If so, block 910 includes documenting that an ADA assessment is necessary, and block 912 includes sending a directed e-mail to an ADA coordinator. The employer can identify the circumstances and then pre-populate the directed e-mails. In one embodiment, an administrator is prompted to send a directed e-mail. If the response to block 908 is “no,” block 914 includes sending a directed e-mail to the administrator regarding the employee's separation rights and benefits.

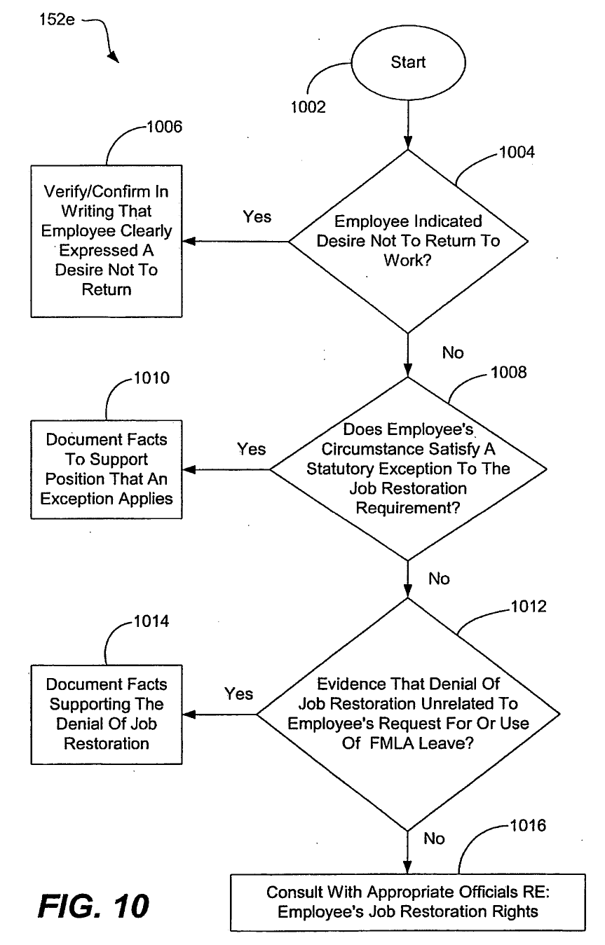

FIG. 10 is a flow diagram that illustrates decision processing corresponding to termination/not-returning under FMLA, according to an embodiment of an absence management method 152e. Proceeding from the start block 1002, a query is made to determine if the employee has indicated a desire not to return to work (block 1004). If he or she has indicated such a desire (“yes”), then block 1006 includes verifying/confirming in writing that the employee clearly expressed a desire not to return. Otherwise, decision processing proceeds to block 1008, wherein a query is made to determine whether the employee's circumstances satisfy one of the statutory exceptions to the job restoration requirement. If the response to this query is affirmative, then block 1010 includes documenting facts to support the position that an exception applies. Otherwise, decision processing proceeds to block 1012, wherein a query is made to determine if there is evidence that denial of job restoration is unrelated to the employee's request for or use of FMLA leave. If the response is affirmative to this query, block 1014 includes documenting facts supporting the denial of job restoration. Otherwise, decision processing proceeds to block 1016, which includes directing the administrator to consult with appropriate officials regarding the employee's job restoration rights.

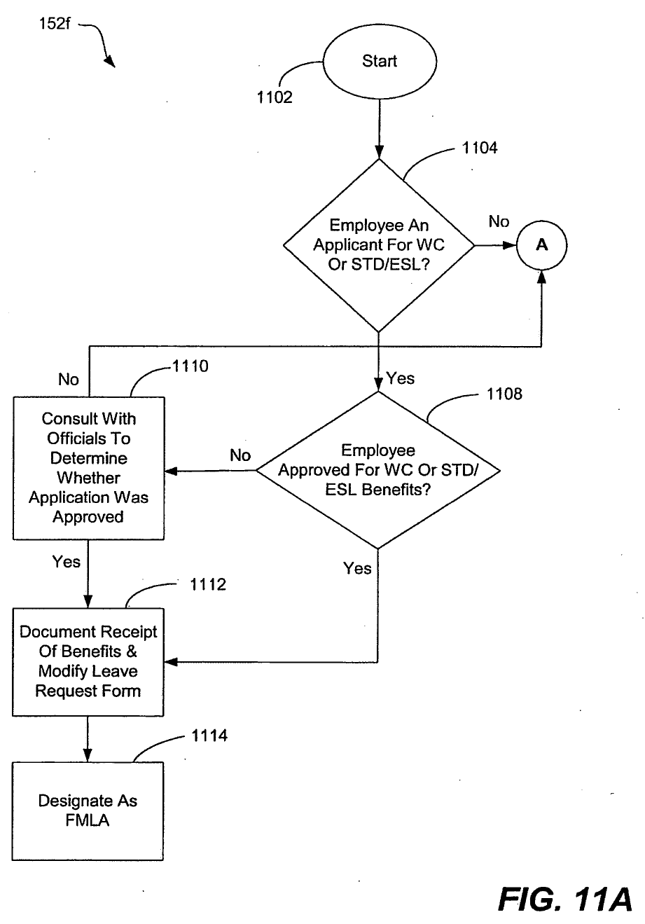

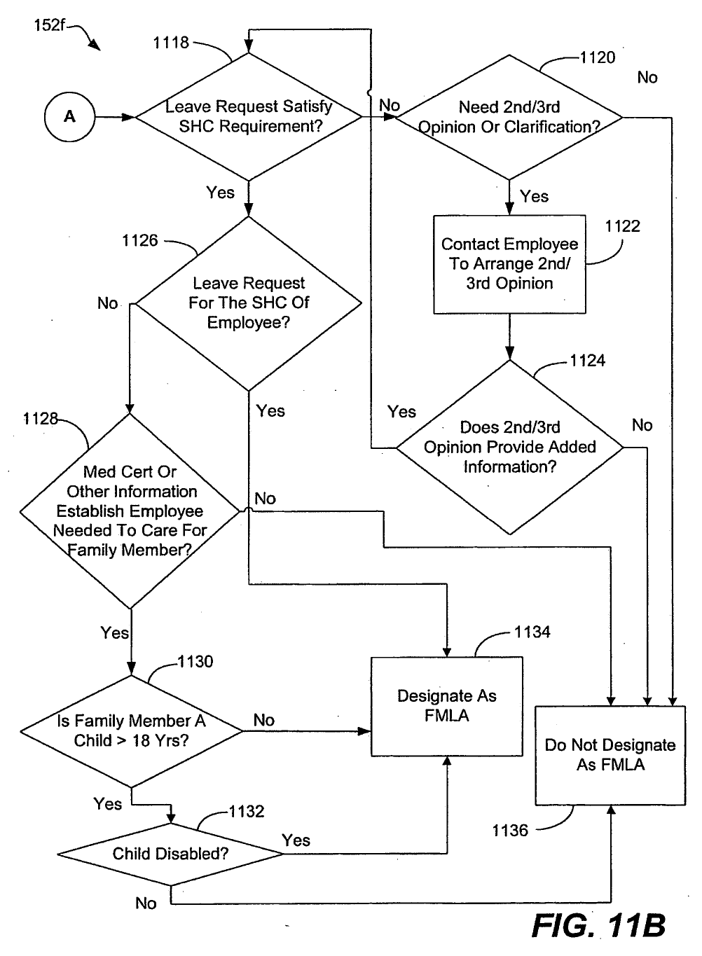

FIGS. 11A-11B are flow diagrams that illustrate decision processing corresponding to serious health conditions, according to an embodiment of an absence management method 152f. Proceeding from start block 1102, a query is made to determine whether the employee is an applicant for worker's compensation or short-term disability/extended leave (block 1104). If not, decision processing proceeds to block A, from which further processing is later described for FIG. 11B. For an affirmative response to block 1104, a query is made in block 1108 to determine if the employee has been approved for worker's compensation or short-term disability/extended leave benefits. If approved, processing continues at block 1112 explained below. If not approved, block 1110 includes consulting with appropriate officials to determine whether the application is approved. The absence management method 152f prompts the administrator to seek information from an appropriate official as he or she steps through the decision tree. The administrator can then send a directed e-mail to the appropriate official. If the application is not approved, processing proceeds to block A. If the application is approved, block 1112 includes documenting receipt of benefits and modifying the leave request form for that employee (e.g., as prompted by the absence management system 152 (FIG. 1B)). In some embodiments, the documenting may occur automatically if a payroll system was providing such information. Block 1114 includes designating the leave request as FMLA.

Referring to block A (from FIG. 11A) in FIG. 11B, processing continues to block 1118. Block 1118 includes querying whether the leave request satisfies a serious health condition (SHC) requirement. Some exemplary SHC requirements include in-patient care, continuing treatment under the care or direction of a health care provider, and periods of incapacity of more than three days including treatment. If not, block 1120 includes determining whether a 2^{nd} or 3^{rd} opinion or clarification is needed. If not needed, a determination is made not to designate the leave request under FMLA in block 1136. If a 2^{nd} or 3^{rd} opinion is needed (block 1120), the employee is contacted to arrange a 2^{nd} or 3^{rd} opinion in block 1122, and a further query is made in block 1124 to determine whether the additional opinion provides added information. If it does not add information, then the leave request is not designated as FMLA (block 1136), otherwise processing returns to block 1118.

If the leave request satisfies the SHC requirement (block 1118), then an additional query is made to determine whether the leave request is for the SHC of the employee (block 1126). If so, the leave request is designated as FMLA (block 1134). If not, processing continues to block 1128 to determine whether medical certification or other information establishes that the employee needs to care for a family member. If no care for a family member is to be provided by the employee, then the leave request is not designated as FMLA (block 1136). If care is to be provided to a family member, processing continues to block 1130 to determine whether the family member is a child over 18-years in age. If not, the leave request is designated as FMLA (block 1134). If the family member is over the age of 18-years, processing continues to block 1132 to determine whether the child is disabled. If so, the leave request is designated as FMLA (block 1134), otherwise it is not designated as FMLA (block 1136).

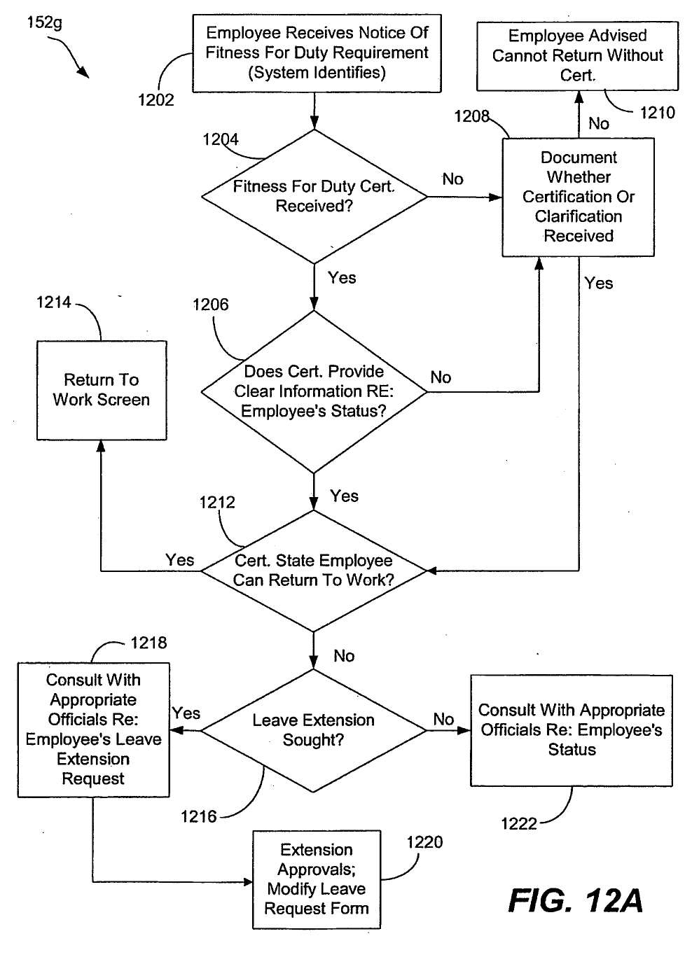

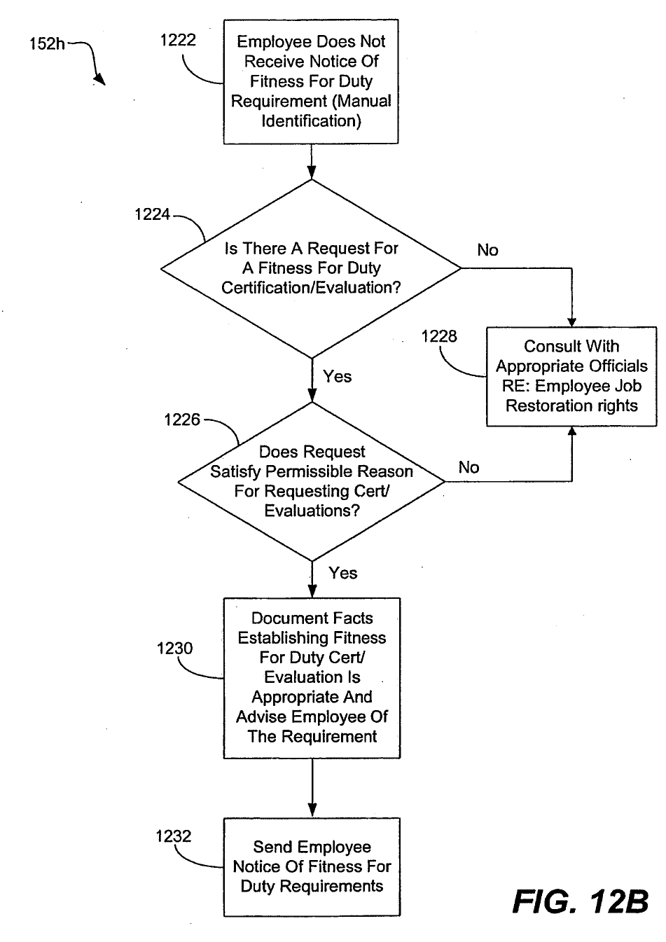

FIGS. 12A-12B are flow diagrams that illustrate decision processing corresponding to fitness for duty (FMLA), according to embodiments of absence management methods 152g and 152h, respectively. Referring to FIG. 12A, block 1202 corresponds to a circumstance where the employee has received notice of fitness for duty requirements (e.g., as identified automatically by the absence management system 152 (FIG. 1B)). In block 1204, a query is made to determine whether the fitness for duty certification was received. If not, the block 1208 includes documenting whether the certification or clarification was received. If received, processing continues to block 1212 to determine if certification states employee can return to work. If not received (from block 1208), then processing proceeds to block 1210 where the employee is advised that he or she cannot return without the certification. If the fitness for duty certification was received (block 1204), block 1206 includes determining whether the certification provides clear information regarding the employee's status. If not, then processing continues to block 1208 to document that the certification was unclear. If the certification does provide clear information regarding employee status (from block 1206), a query is made to determine whether the certification states that the employee can return to work in block 1212. If so, block 1214 includes prompting a return-to-work screen that is implemented as part of return-to-work decision processing. If not, processing continues to block 1216 to determine whether leave extension is sought. If no leave extension is sought, processing continues to block 1222 to consult with appropriate officials regarding the employee's status. If leave extension is sought, block 1218 includes consulting with appropriate officials regarding the employee's leave extension request, and then in block 1220, modifying the leave request form in light of any extension approvals.

FIG. 12B is a flow diagram of an embodiment of an absence management method 152h for fitness for duty issues under FMLA prompted manually. Block 1222 includes receiving user input that informs the absence management method 152h that the employee did not receive a notice of fitness for duty. Block 1224 includes determining whether there is a request for a fitness for duty certification/evaluation. If not, consultation with appropriate officials occurs in block 1228 regarding the restoration of employee job rights. If there is a request (block 1224), block 1226 includes determining whether the request satisfies a permissible reason for requesting the certification/evaluation. If there is not a permissible reason, processing is directed to block 1228 to consult with appropriate officials as explained above. Otherwise, processing continues to block 1230 to document the facts establishing that fitness for duty certification/evaluation is appropriate and thus advising employee of this requirement. In block 1232, the employee is sent a notice regarding the fitness for duty requirements. In practice, the administrator sends a notice letter to the employee of the facts identified in block 1230 as supporting the request for a fitness for duty certification. For example, in medical documentation provided to the employee to support the need for leave, the employee's physician states that stress in the work place was making the employee suicidal.

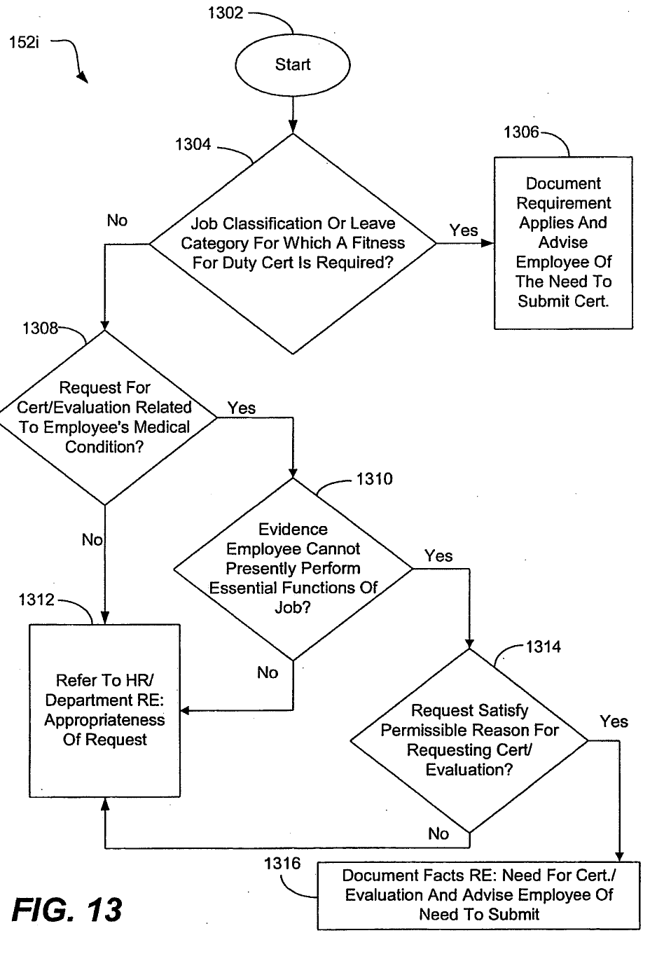

FIG. 13 is a flow diagram that illustrates decision processing corresponding to fitness for duty under non-FMLA, according to an embodiment of an absence management method 152i. Proceeding from start block 1302, a query is made in block 1304 to determine whether this circumstance is a job classification or leave category for which a fitness for duty certification is required. If so, block 1306 includes documenting that the requirement applies and advising the employee of the need to submit the certification. If not (from block 1304), then a query is made in block 1308 to determine whether the request for certification/evaluation is related to the employee's medical condition. If not, the case is referred to the human resource (HR) department or employee department concerning the appropriateness of the request (block 1312). If the request is related to the employee's medical condition (block 1308), then a query is made in block 1310 to determine whether there is evidence that the employee cannot presently perform the essential functions of the job. If there is no evidence, the case is referred to the HR department or employee department (block 1312). If there is evidence, a query is made in block 1314 to determine whether the request satisfies one of the permissible reasons for requesting a certification/evaluation. If not under one of the permissible reasons, the case is referred to the HR department or employee department (block 1312), otherwise the facts regarding the need for certification/evaluation are documented and the employee is advised of the need to submit the same in block 1316.

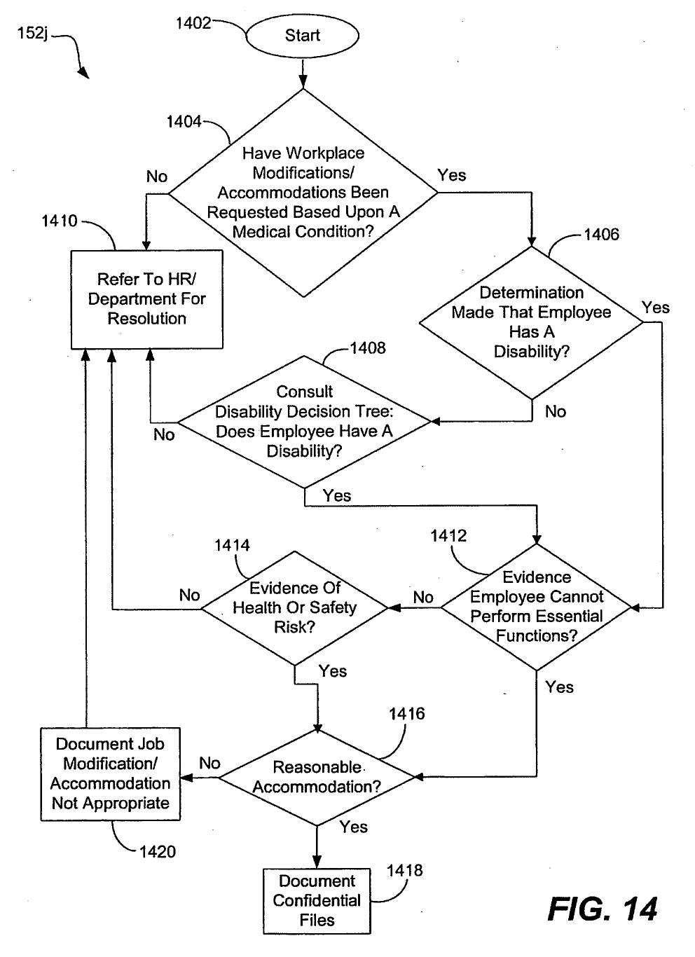

FIG. 14 is a flow diagram that illustrate decision processing corresponding to job restructure/accommodation, according to an embodiment of an absence management method 152j. Proceeding from block 1402, block 1404 includes determining whether workplace modifications/accommodations have been requested based on a medical condition of the employee. If not, the case is referred to the HR department for resolution in block 1410. If modifications or accommodations have been requested (block 1404), block 1406 includes determining whether a determination has been made that the employee has a disability. If there is no such determination, block 1408 includes consulting a disability decision tree to determine if the employee has a disability. If there is no disability, processing proceeds to block 1410 as described above. If there is a disability (block 1408) or if a determination was made that the employee has a disability (block 1406), processing continues to block 1412. Block 1412 includes determining whether there is evidence that the employee cannot perform essential functions. If there is no evidence, block 1414 includes determining whether there is evidence of a health or safety risk. If there is no risk, processing proceeds to block 1410. If there is a risk (block 1414) or evidence that the employee cannot perform essential functions (block 1412), block 1416 includes determining whether a reasonable accommodation is available. If not, block 1420 includes documenting that the job modification/accommodation is not appropriate, and then the case is referred to the HR department in block 1410. If a reasonable accommodation is available (block 1416), then processing continues to block 1418 to document confidential files.

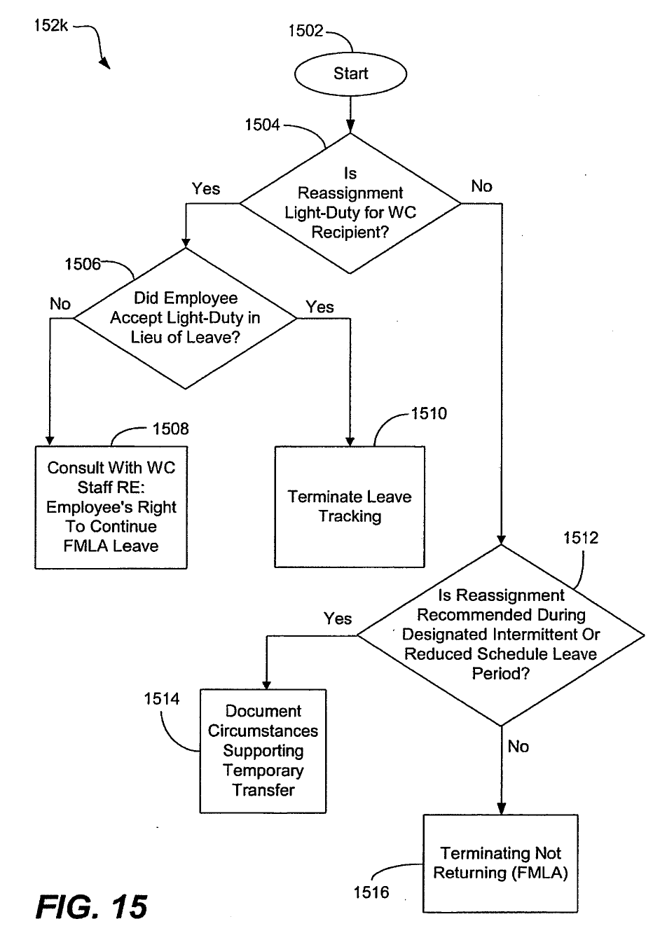

FIG. 15 is a flow diagram that illustrates decision processing corresponding to reassignment/light-duty under FMLA, according to an embodiment of an absence management method 152k. Proceeding from start block 1502, block 1504 includes determining whether the reassignment is a light-duty assignment for a worker's compensation recipient. If so, block 1506 includes determining whether the employee accepted the light-duty assignment in lieu of leave. If so, block 1510 includes terminating leave tracking. If employee did not accept light-duty in lieu of leave (block 1506), block 1508 includes consulting with worker's compensation staff regarding employee's right to continue FMLA leave. If reassignment is not light-duty (block 1504), block 1512 includes determining whether the reassignment is recommended during a designated intermittent or reduced schedule leave period. If so, then block 1514 includes documenting the circumstances that support the temporary transfer. Otherwise, processing continues to block 1516 to terminate the not returning processing under FMLA. Under FMLA, the employee has job restoration rights. Thus, if the light-duty assignment does not satisfy the worker's compensation or temporary assignment circumstances, then it is a case that is to be considered under the terminating not returning to work decision tree to ensure that the employee's job restoration rights have not been violated.

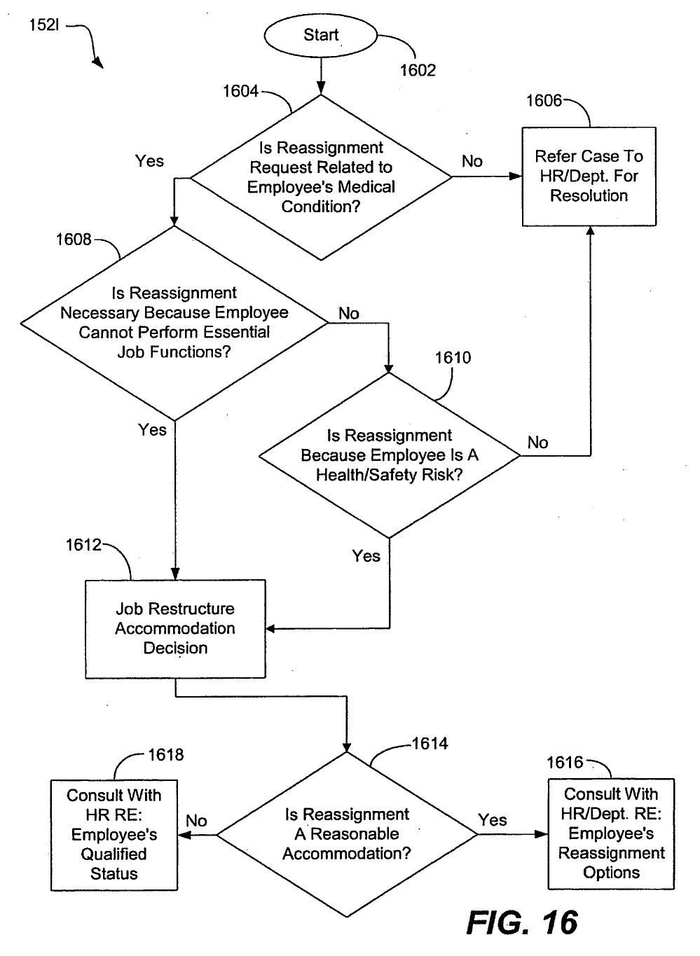

FIG. 16 is a flow diagram that illustrates decision processing corresponding to reassignment/light-duty for non-FMLA circumstances, according to an embodiment of an absence management method 1521. Proceeding from start block 1602, block 1604 includes determining whether the reassignment request is related to a medical condition of the employee. If not, the case is referred to the HR department for resolution in block 1606. If it is related (block 1604), processing continues to block 1608. Block 1608 includes determining whether the reassignment is necessary because the employee cannot perform essential job functions. If not necessary, processing continues to block 1610 to determine whether reassignment is due to the employee being a health or safety risk. If not, processing advances to block 1606. If reassignment is because of health or safety concerns (block 1610) or if reassignment is necessary because the employee cannot perform essential job functions (block 1608), then processing continues to block 1612. Block 1612 includes making a job restructuring/accommodation decision. The absence management method 1521 prompts a directed e-mail to the appropriate official to determine whether the employee has rights under the ADA. Block 1614 includes determining whether reassignment is a reasonable accommodation. If so, block 1616 includes consulting with the HR department regarding employee's reassignment options. If not (block 1614), block 1618 includes consulting with the HR department regarding employee's qualified status.

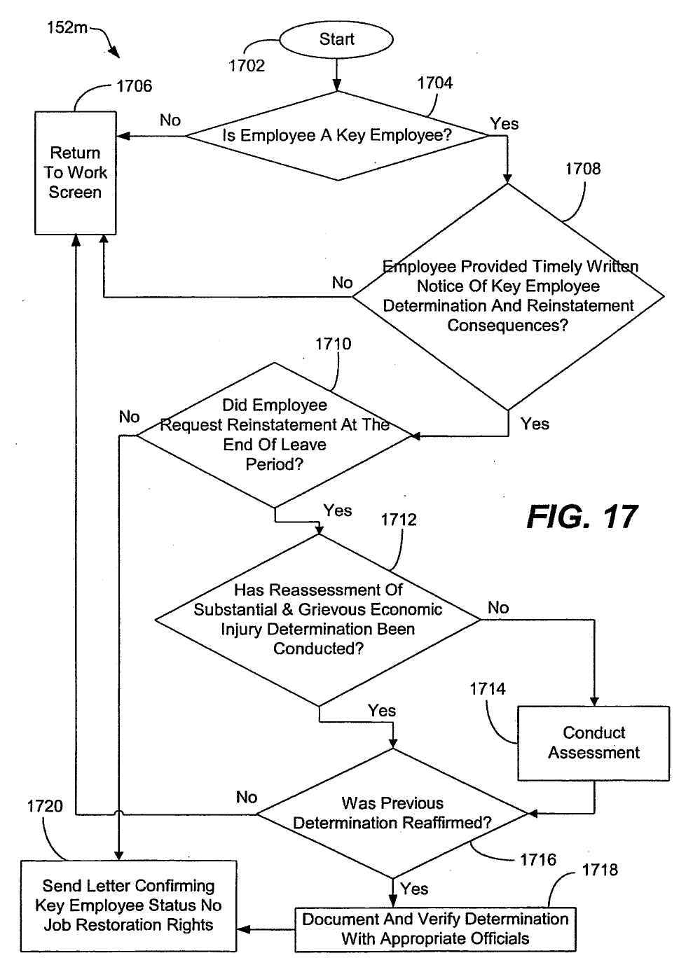

FIG. 17 is a flow diagram that illustrates decision processing corresponding to key employees, according to an embodiment of an absence management method 152m. Proceeding from start block 1702, block 1704 includes determining whether the employee is a key employee. If not, processing continues to block 1706 to the return-to-work screen. Otherwise, processing continues to block 1708 to determine whether the employee was provided timely written notice of key employee determination and reinstatement consequences. If not, processing continues to block 1706. If so, processing continues to block 1710. Block 1710 includes determining whether the employee requested reinstatement at the end of the leave period. If the employee did request reinstatement, processing continues to block 1712 to determine whether there has been a reassessment of a determination of substantial and grievous economic injury. If not, an assessment is conducted in block 1714. If a reassessment has been conducted (block 1712), or after the assessment is conducted (block 1714), block 1716 includes determining whether the previous determination was reaffirmed. If not, processing continues to the return-to-work screen in block 1706. Otherwise, processing continues to block 1718 to document and verify the determination with appropriate officials. In block 1720, a letter is sent confirming key employee status and no job restoration rights.

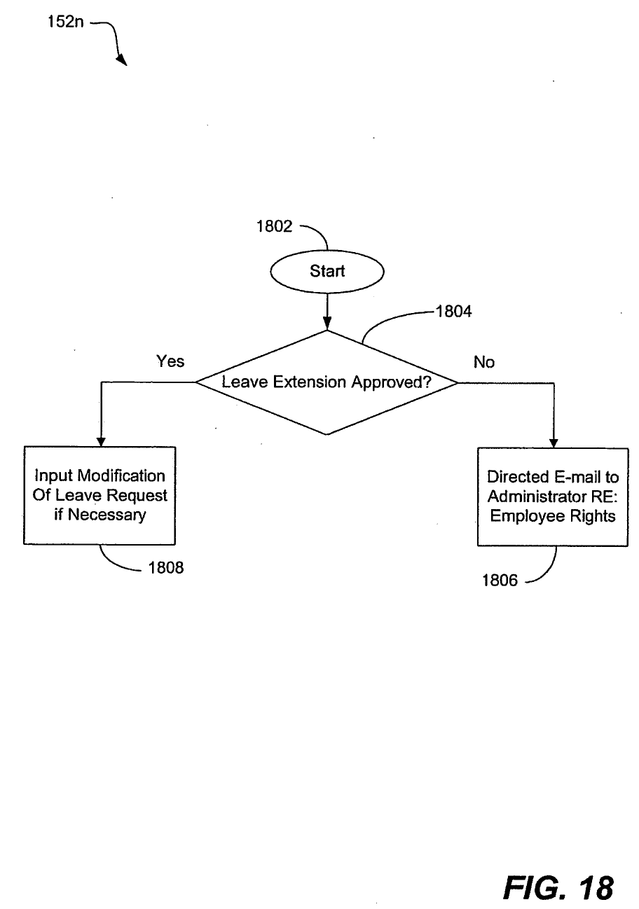

FIG. 18 is a flow diagram that illustrates decision processing corresponding to a leave extension, according to an embodiment of an absence management method 152n. Proceeding from the start block 1802, block 1804 includes determining whether leave extension has been approved. If not, a directed e-mail is generated to the administrator regarding the rights of the employee (block 1806). Otherwise, the operator is instructed to input a modification of the leave request if necessary (block 1808).

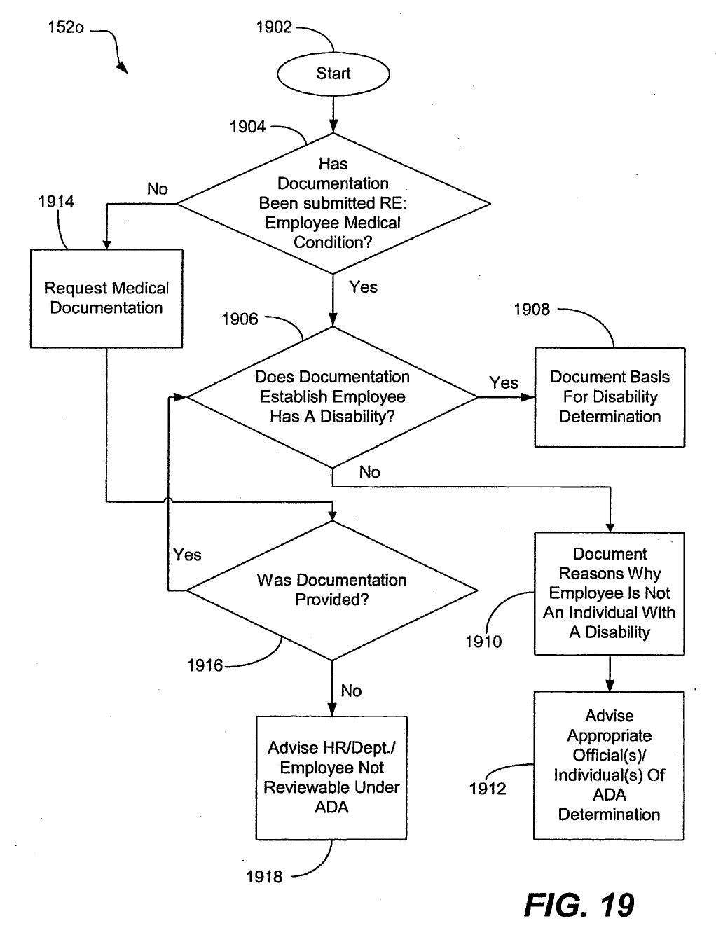

FIG. 19 is a flow diagram that illustrates decision processing corresponding to defining disability, according to an embodiment of an absence management method 152o. Proceeding from the start block 1902, block 1904 includes determining whether documentation has been submitted regarding the medical condition of the employee. If so, block 1906 includes determining whether the documentation establishes that the employee has a disability. If so, block 1908 includes documenting the basis for the disability. If not (block 1906), block 1910 includes documenting the reasons why the employee is not an individual with a disability. Block 1912 includes advising the appropriate officials of the ADA determination. If documentation has not been submitted regarding the employee's medical condition (block 1904), block 1914 includes requesting medical documentation. Block 1916 includes determining whether documentation was provided. If so, processing continues to block 1906 as described above. Otherwise, processing continues to block 1918, which includes advising the HR department that the employee is not reviewable under ADA.

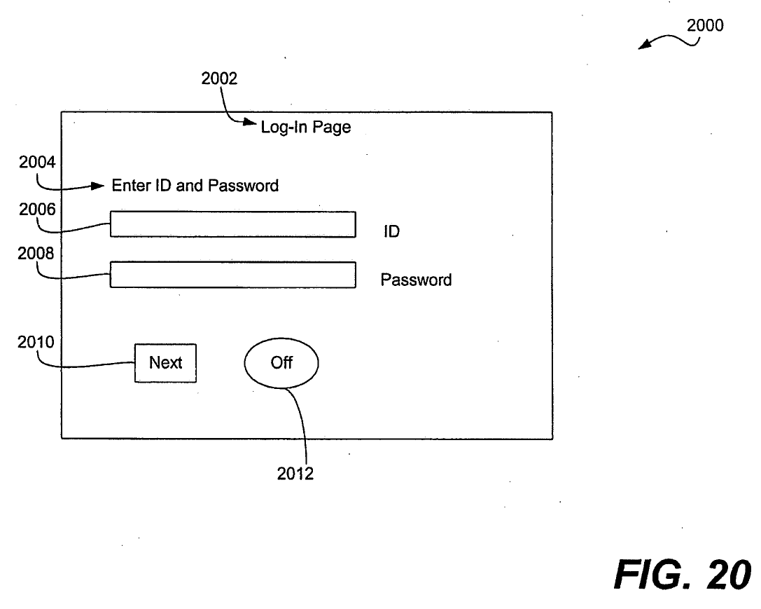

FIGS. 20-28E illustrate several exemplary screen diagrams that can be generated by the absence management system 152 (FIG. 1B) to enable an administrator to process and track leave requests. The example screen diagrams help illustrate the underlying processing of the absence management method embodiments 152a-152o. These example screens provide one example implementation among many, and other screen configurations for processing and tracking leave requests are possible. Additional implementations can be found in the provisional application to which priority is claimed.

FIG. 20 is a screen diagram of an example login page 2000 used by an administrator (e.g., supervisor or leave administrator) working in cooperation with the absence management system 152 (FIG. 1B). Users of the absence management system 152 are entered through a setup menu (not shown). An “add user” menu option (not shown) of a set-up menu allows a system administrator to choose an employee to be set up as an employee user and/or supervisor, among other categories or job titles. An entry form (not shown) in the set-up menu allows selection of a login ID (by default, the employee's ID number) and access type. User IDs are preferably unique system-wide. To create, for example, an administrator that is employed as a supervisor without access to the system (so he/she appears in the supervisor drop down lists), password fields (not shown) are left blank. To disable an existing user, one mechanism is to change the password or user ID to an “unguessable” value.

The login page 2000 includes a title 2002, an instruction line 2004, an ID window 2006, a password window 2008, a next button icon 2010, and an off button icon 2012. The login page 2000 is preferably used by an administrator to enter a unique ID and password. An initial ID and password can be assigned by a system administrator (e.g., in an IT department). If an administrator forgets his or her password, a system administrator can assign a new one. As shown, the instruction line 2004 provides an administrator with guidance as to what he or she is to do with the login page 2000. An administrator can provide text entry to the ID window 2006 and text entry to the password window 2008. After entering the information, an administrator can select the next button icon 2010 to proceed. Otherwise, an administrator can logoff at this point by selecting the off button icon 2012.

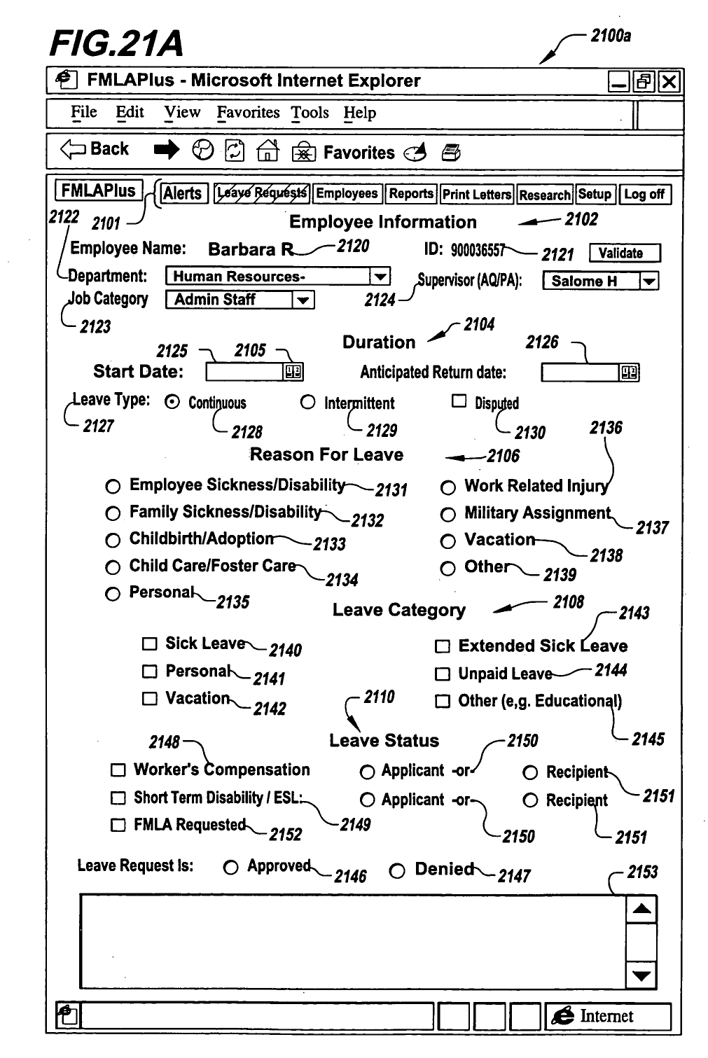

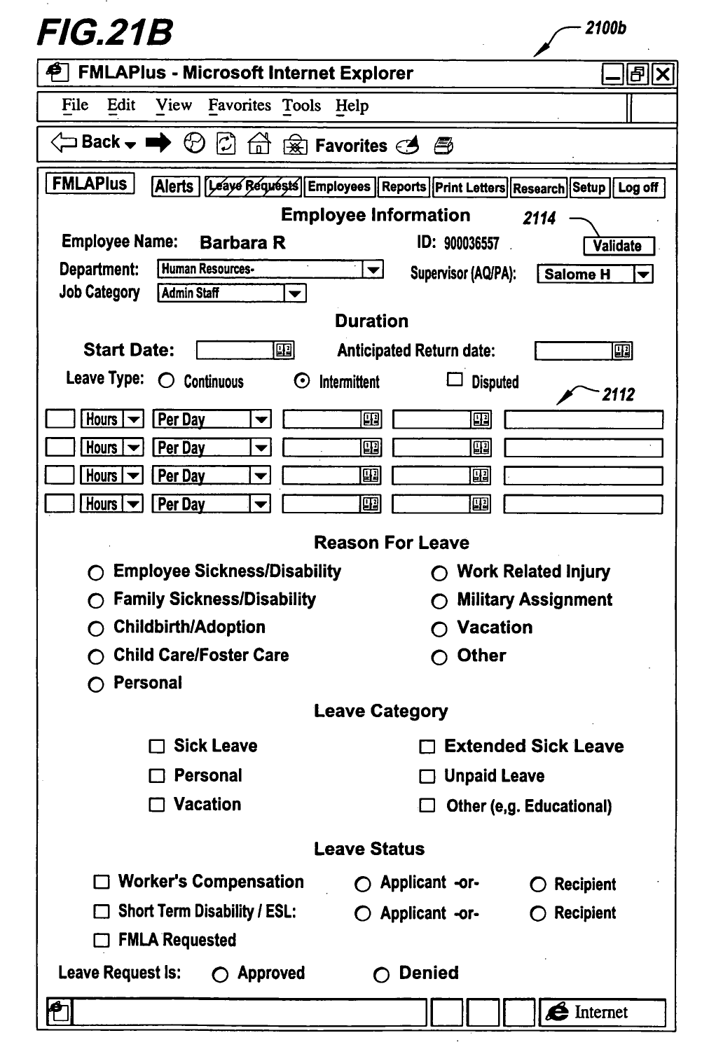

FIG. 21A is an example leave request form 2100a. In one implementation, leaves selected for processing (e.g., leave requests of five or more days) are recorded using the leave request form 2100a. Administrators with user ID login privileges may submit requests. Sections of the leave request form 2100a left unanswered may result in a prompt that requests information. The primary sections of the leave request form 2100a include a main menu bar 2101 with selectable options (described in association with other screen diagrams), an employee information section 2102, a duration section 2104, a leave reason section 2106, a leave category section 2108, and a leave status section 2110. In the employee information section 2102, the employee's name 2120 or ID number 2121 is entered to activate the leave request form 2100a. Pertinent information regarding the employee, such as department association 2122 and job category 2123, will be pre-populated from the employer data feed (e.g., import data file 200, FIG. 2) except for the administrator's (e.g., supervisor's) name 2124. Employee information is preferably displayed to verify that the correct employee has been selected. The administrator may optionally be set up with department and/or organization unit access. The first time an administrator, such as a supervisor, submits a leave request for an employee, the supervisor enters his or her name in the leave request form 2100a. Thereafter, the absence management system 152 (FIG. 1B) pre-fills his or her name. The employee data in the leave request form 2100a cannot be changed or altered. The administrator may add employee information for employees whose pertinent information is not part of the data feed. There is a menu item for entering new employees into the system under the employees icon of the main menu bar 2101. In one embodiment, the employees icon, when selected, provides a drop down menu for new employee information that the absence management system 152 uses to process a leave for the employee until the next time the data feed is refreshed.

The administrator enters information for the start date 2125 and anticipated return date 2126 for the leave in the duration section 2104. Dates may be entered either by selecting a calendar icon 2105 to invoke a calendar for date selection or typing in the actual dates. Dates can be entered as MM/DD or MM/DD/YY. If the year is not supplied, the current year is used. If the anticipated return date is unknown, the absence management system 152 (FIG. 1B) will default to the ESL/STD expiration date (six months). Under such circumstances the administrator may enter the actual return date as a request modification if and when the information is provided.

The duration section 2104 also includes selectable options 2127 for the leave type, including continuous leave 2128, intermittent leave 2129, and disputed leave 2130. Continuous leave 2128 should be selected if the employee is absent from work full-time. If there is a dispute regarding the eligibility, entitlement, or designation of an employee's leave under FMLA, the administrator should check disputed 2130.

Intermittent leave 2129 should be selected if the employee is working part of his or her work schedule (e.g., reduced scheduled leave) and on leave for the remainder of the time or is absent from work on an intermittent basis during the leave period. When intermittent leave 2129 is selected, four entry lines 2112 appear to record the time(s) to be scheduled, as shown in the leave request form 2100b of FIG. 21B. If more than four entries are needed, the administrator will preferably enter the first four entries and press a validate button icon 2114 to go to a review screen (not shown). From the review screen, the administrator can choose a make-changes icon (not shown) to prompt an additional four entry lines.

Referring again to FIG. 21A, the leave reason section 2106 includes several selectable options for recording the stated reason given by the employee for taking and/or requesting the leave. These options include employee sickness/disability 2131, family sickness/disability 2132, childbirth/adoption 2133, child care/foster care 2134, personal 2135, work-related injury 2136, military assignment 2137, vacation 2138, and other 2139. In one embodiment, only one reason may be selected.

The leave category section 2108 provides selectable options to enable the administrator to request a designation of the manner in which the employee will receive pay or benefits during the leave period. These options include sick leave 2140, personal 2141, vacation 2142, extended sick leave 2143, unpaid leave 2144, and other 2145. If the employee's leave falls within more than one category (e.g., the employee requests six weeks of leave comprising four weeks of sick leave 2140 and two weeks of unpaid leave 2144), the administrator is to select the appropriate categories and record the relevant dates for each. The absence management system 152 (FIG. 1B) provides a prompt (not shown) requesting dates for instances in which more than one category is selected.

The leave status section 2110 provides options for selecting the type of leave requested and whether the leave has been approved 2146 or denied 2147. Options include worker's compensation 2148 and short-term or long-term disability 2149 for the either the applicant 2150 or a recipient 2151, and whether FMLA has been requested 2152. Note the distinction between applicant and recipient. If the individual is a recipient, the absence management system 152 automatically designates as FMLA concurrent administration. If the individual is an applicant, the absence management system 152 provides prompts during the serious health condition processing to resolve concurrent administration status. If or when the employee or his or her representative specifically requests FMLA leave, even after the initial request has been submitted, it is recorded on the leave request form 2100a either as a part of the initial request or a subsequent leave change (modification). Once a leave has been designated FMLA, in one embodiment, the reason 2106 and type (continuous/intermittent) 2127 cannot be changed, and those entries will not be visible. If one of these changes, a new leave request form is generated.

If the leave is denied, a specific reason is recorded in the notes window 2153 of the leave status section 2110. If a leave is entered pending approval based on future information, the denied option 2147 is selected and, under the leave reason section 2106, the other option 2139 is selected. If the leave is subsequently approved, a review/update menu (not shown) located as a side bar menu (not shown) in, for example, a supervisor's screen (not shown, but a “slimmed-down” version of the administrator's screen) can be prompted to mark the approval status.

Prior to the start of the leave period, any change can be made to the request, including cancellation of the leave, and history of the modification will be retained by the absence management system 152 (FIG. 1B). Subsequent to the start of the leave period and during tracking, changes of an employee's leave are recorded by entering the change on the leave request form 2100a. Such changes can be made be choosing the employee's open leave request and selecting one of the following menu choices from a supervisor's screen (not shown, but configured similarly to an administrator's screen with the following options in a side-bar menu): “Review/Update,” “Make Changes,” or “Change Request.” Preferably by entering a new leave request, a new leave alert is triggered to the administrator who may either handle the case or assign it to another administrator.

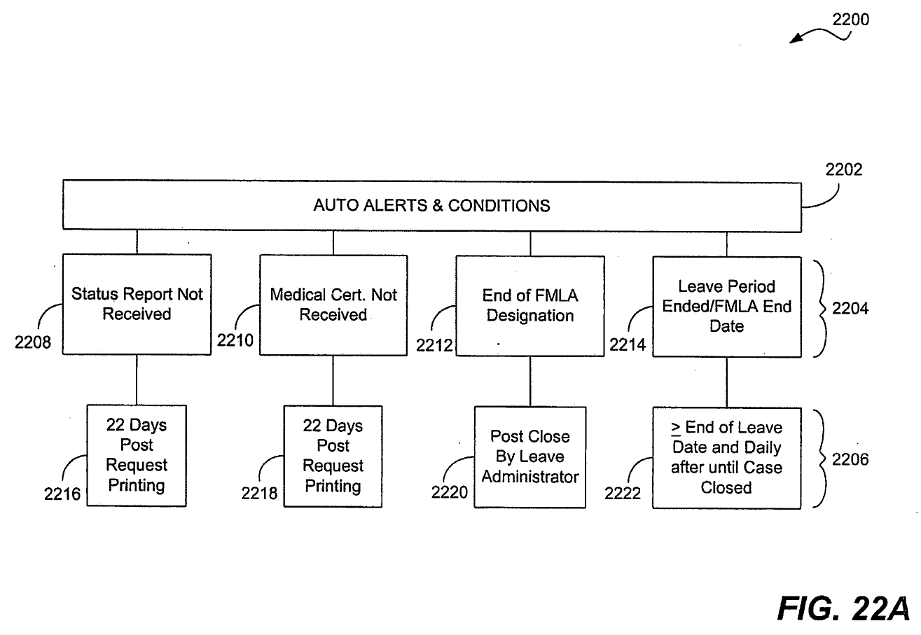

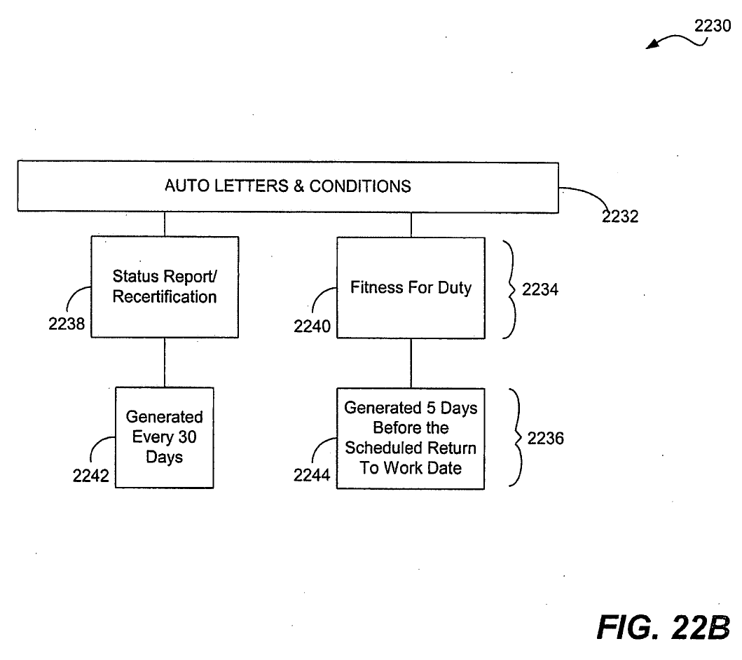

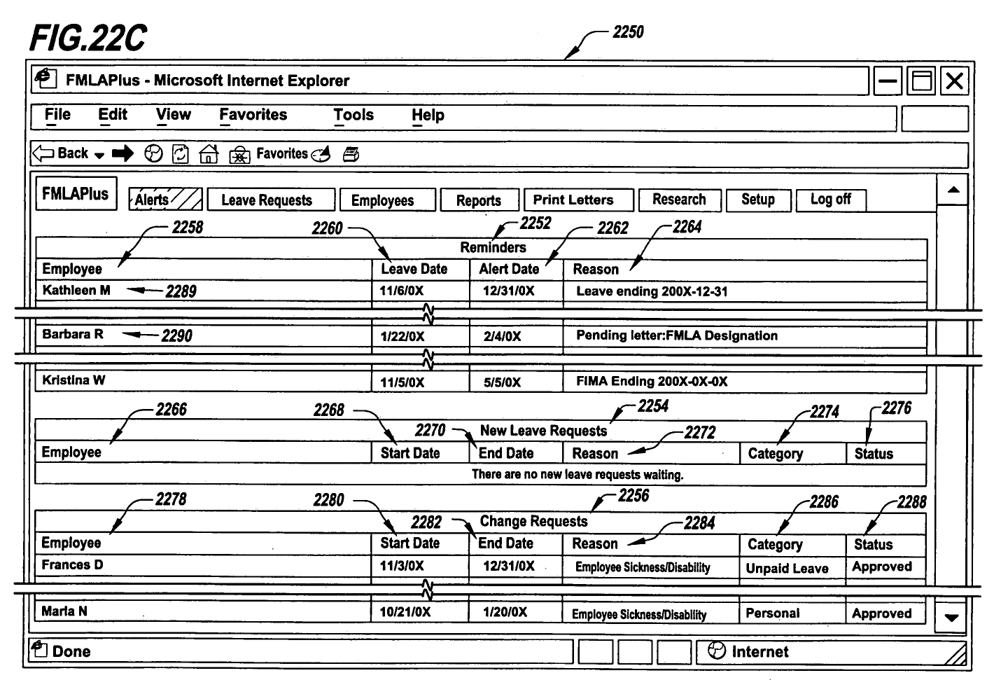

FIGS. 22A-22C are schematic and screen diagrams that illustrate the automatic alert functionality of the absence management system 152 (FIG. 1B). Alerts preferably fall into three categories: new leave requests, change requests, and reminders. New leave requests are those which have not yet received an initial designation, whether or not changes have been made since the original request. Change requests are instances where a designation has already been made, but information has changed that might affect the designation (for example, an extension request or change of reason). Reminders include pending notifications and actions required. Reminders are generated by specific events, which then require an administrator or other person to take direct action. For example, when a medical certification is received, the action will be to enter the serious health condition decision tree. If the action required is a function in the application, selecting the action takes the administrator to the appropriate screen. The reminder might also be a suggestion for an action outside of the system. For example, if a medical certification has not been received five days after the reminder letter, the administrator is alerted and may contact the employee directly. Thus, pending notifications are letters to be printed for employees. Actions required are for circumstances where a due date for some action, such as a return-to-work or medical certification, is approaching or has been passed.

FIG. 22A is a schematic diagram that illustrates some automatic alert mechanisms of the absence management system 152 (FIG. 1B). The diagram 2200 includes a title block 2202 that is entitled “Auto alerts and Conditions,” and a second tier of title blocks 2204 that include the auto alerts, and finally a third tier of condition blocks 2206 that include the conditions that prompt these auto alerts from occurring. The blocks of auto alerts 2204 include the alert that the status report has not been received represented in block 2208, a medical certification has not been received alert represented by block 2210, an end of FMLA designation alert represented by block 2212, and a leave period ended/FMLA end date alert represented by block 2214. The condition for a status report not received alert of block 2208 is that of fifteen days after the request for this report has been printed as represented by block 2216. Block 2218 shows the condition for sending out a medical certification not received alert, and this condition is when fifteen days after the request for printing this certification has occurred. The end of FMLA designation represented in block 2212 occurs in response to the closing of this designation by an administrator, as indicated by block 2220. The leave period ended block 2214 occurs under the condition that an end of leave date has occurred and continues daily until the case is closed, as indicated by block 2222. Note that the condition periods and/or triggering events can be configured differently in some embodiments.

FIG. 22B provides a schematic diagram 2230 of the automatic letter generation mechanisms and corresponding conditions that occur in the absence management system 152 of FIG. 1B. The diagram 2230 includes a title block 2232 that shows that this schematic represents automatic letter generation and corresponding conditions. The types of letters are indicated in section 2234, including blocks 2238 for representing status report/re-certification letter generation, and fitness for duty letter generation represented in block 2240. The conditions for the status report/re-certification are illustrated by block 2242, which indicates that the letter is generated every thirty days. The condition for automatic letter generation of fitness for duty is indicated by block 2244, which indicates that it is generated five days before the scheduled return to work date. Note that the condition periods and/or triggering events can be configured differently in some embodiments.

FIG. 22C is a screen diagram of an example alert screen 2250. For example, when an administrator logs onto the absence management system 152 (FIG. 1B), he or she can be presented with the alert screen 2250. The alert screen 2250 provides a summary of active leave requests. As shown, the alert screen 2250 includes a reminder section 2252, a new leave request section 2254, and a change request section 2256. The reminder section 2252 includes an employee column 2258, a leave date column 2260, an alert date 2262, and a reason column 2264. The new leave requests section 2254 includes an employee column 2266, start date column 2268, end date column 2270, reason column 2272, category column 2274, and a status column 2276. Similarly, the change request section 2256 includes an employee column 2278, start date column 2280, end date column 2282, reason column 2284, category column 2286, and a status column 2288.

The text in each row of the sections 2252, 2254, and 2256 provides a link to detailed information for each employee. Further, the reasons can be categorized into two types. One type of reason is where an action is pending before an administrator can take action. For example, in line 2289, the leave ends for this person on Dec. 31, 200X, where 0X represents the applicable year. Until that date has transpired, the administrator does not need to take further action with respect to that person. The other type of reason can be characterized as a “to-do” list for the administrator. For example, in line 2290 of the reminder section 2252, the administrator is reminded that he or she needs to send out a letter on FMLA designation. The differences in reasons can be distinguished by using different colored text (e.g., red text for line 2289, black text for line 2290), or other distinguishing mechanisms such as providing a difference in italics, etc.

The new leave request section 2254 provides the administrator with a glimpse of new leaves that have been entered into the absence management system 152 (FIG. 1B) since the administrator logged-off of the system 152. In this example, there are no new leave requests.

The change request section 2256 provides a list of requests in which an employee (or administrator on behalf of the employee) has requested a change in a leave that has been processed and is currently being tracked. For example, the absence management system 152 (FIG. 1B) may send out a request to an employee for updated medical information on a 30-day period. When the employee sends in the updates, he or she may request an extended leave that can be entered by the administrator.

Note that the alerts page 2250 is, in one embodiment, a read-only page. Changes to the alert page 2250 can be made indirectly when changes are made to an employee's corresponding leave request form 2100a (FIG. 21A) that may require action by the administrator.

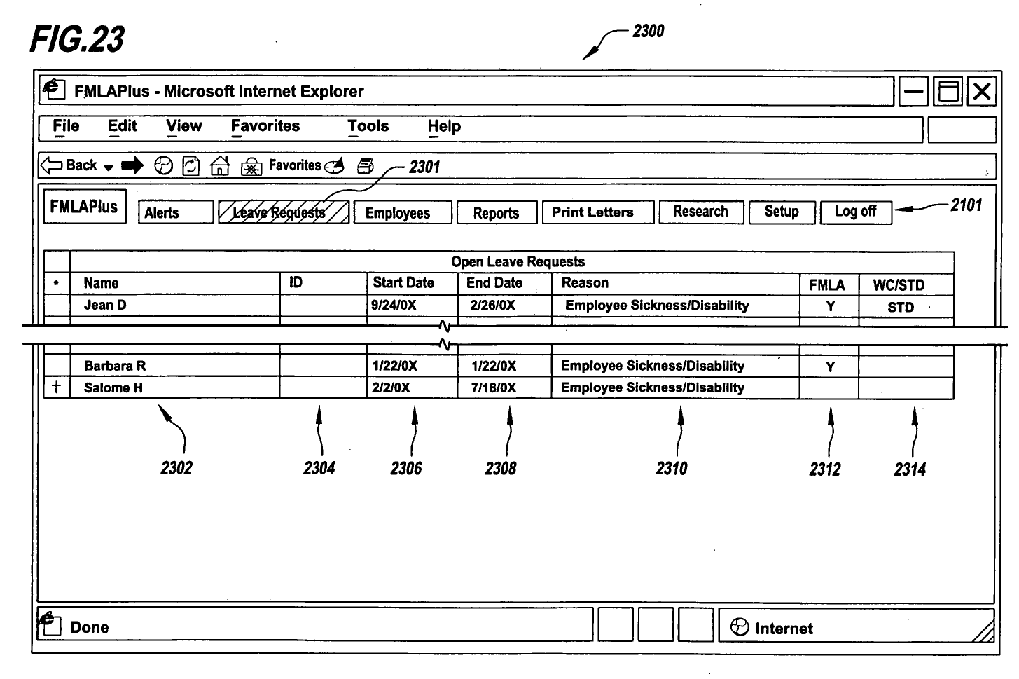

FIG. 23 is an example screen diagram of a leave requests page 2300. The leave requests page 2300 includes all open leave requests. Although configured to present open leave requests, in some embodiments, the leave requests page 2300 can be configured to show all leave requests, whether active or inactive. The leave requests page 2300 is prompted by selecting the leave requests icon 2301 from the main menu 2101 of any web-page. The leave request page 2300 provides the name of the person having an open leave request (column 2302), his or her ID (column 2304), the start date and end date of the leave request (columns 2306 and 2308), and the reason for the leave (column 2310). Further, the leave request page 2300 provides an indication of whether the open leave request is designated FMLA (column 2312), and whether the person is on another program such as worker's compensation, short-term disability, extended sick leave, etc. (column 2314).

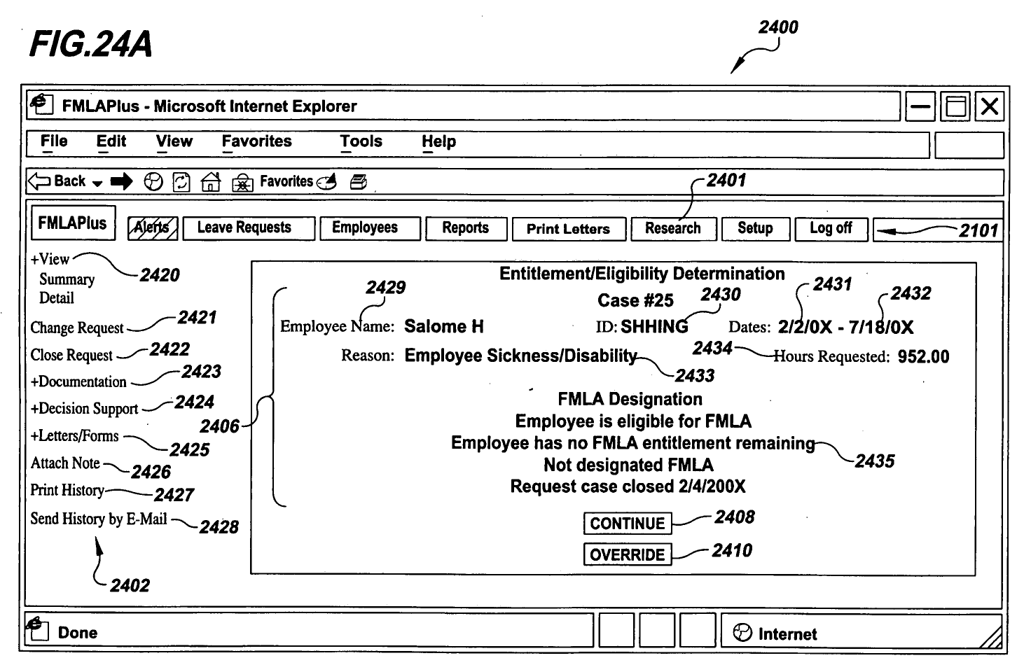

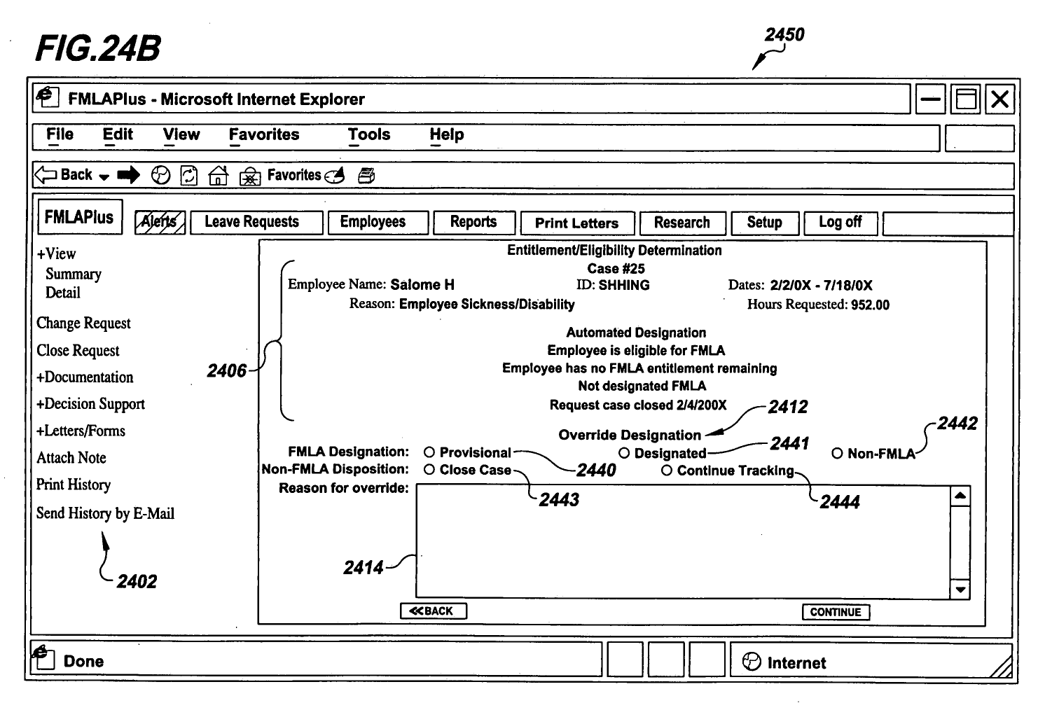

FIG. 24A is an entitlement/eligibility page 2400 prompted by selecting (e.g., double-clicking with a mouse) a person's name in the new leave request section 2254 of the alerts page 2250 (FIG. 22C). The entitlement/eligibility page 2400 provides a side menu 2402 to view a summary detail 2420 of the entitlement/eligibility determination for the employee, to change a request 2421, to close a request 2422, to view documentation 2423, to prompt decision support 2424, to prepare letters or forms 2425, to attach notes 2426, to print a history 2427, or to send a history by e-mail 2428 to designated individuals or departments. Similar functions are found in the main menu 2101 but with a different effect. The side menu 2402 is configured to provide processing of the employee's leave shown in FIG. 24A, whereas selecting the same functional item on the main menu 2101 provides an informational role that does not impact the leave of the employee. For example, selecting the decision support menu item 2424 from the side menu 2402 provides for decision tree processing of a leave for this employee based on the return-to-work issue at stake. In other words, if the employee is terminating and not returning, the decision tree processing prompted through selection of the decision support menu item 2424 will prompt decision tree web-pages corresponding to terminating/not returning issues. On the other hand, if there was a general question regarding the type of decision trees available, the administrator can select the research icon 2401 from the main menu 2101 to review information pertaining to decision tree processing in general.

As shown, the entitlement/eligibility page 2400 also includes a summary section 2406 that includes the employee name 2429, ID 2430, start and end dates (2431 and 2432, respectively) for the leave, the reason for the leave 2433, the hours requested 2434, and the recommended eligibility determination 2435 made by the absence management system 152 (FIG. 1B). In this example, the employee is eligible for FMLA, but has no entitlement remaining, and thus the leave will not be designated FMLA and the case will be closed on the date that the leave was requested (e.g., Feb. 4, 200X).

The entitlement/eligibility page 2400 further includes a continue button icon 2408 and an override button icon 2410. If the administrator agrees with the system recommendation regarding entitlement/eligibility, he or she selects the continue button icon 2408 and the system will close-out this case for FMLA purposes (and if approved, will continue to track the leave).

If the administrator disagrees with the recommendation, he or she can select the override button icon 2410. For example, for employees with part-time work schedules (e.g., 17 ^{1/2} hours or less), the administrator may select the override button icon 2410 to provide FMLA designated leave based upon an employer's 50% policy. In response to this latter selection, the administrator is presented with an override designation page 2450, as shown in FIG. 24B. Similar to the entitlement/eligibility page 2400, the override designation page 2450 includes the side menu 2402 and summary section 2406. Additionally, the override designation page 2450 includes an override designation section 2412 and an explanation window 2414. The override designation section 2412 includes such options as a provisional FMLA designation 2440, a designated FMLA leave 2441, or a non-FMLA leave 2442. For non-FMLA dispositions, options include closing the case 2443 and continuing tracking 2444. The administrator also provides a reason for the override in the explanation window 2414. In one embodiment, the absence management system 152 (FIG. 1B) will not continue processing the leave unless the administrator provides a reason for the override in the explanation window 2414. For example, if the administrator exits from the override designation page 2450 without entering a reason in the explanation window 2414, an alerts screen, such as alerts screen 2250 (FIG. 22C), will include text in the reminder section 2252 (FIG. 22C) advising the administrator that a reason needs to be entered for that particular employee before processing is to proceed.

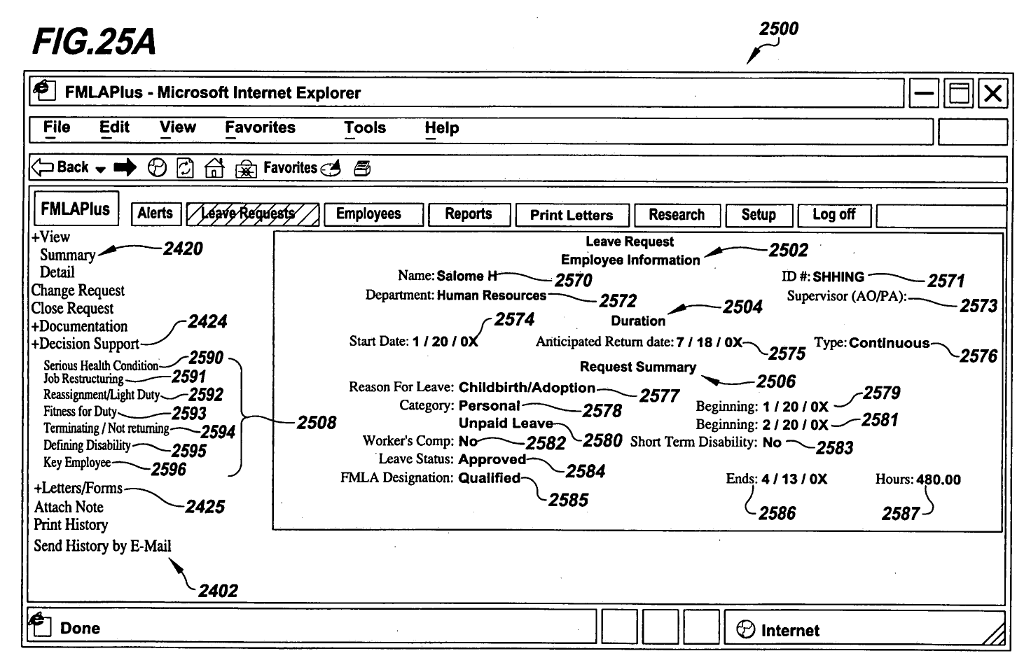

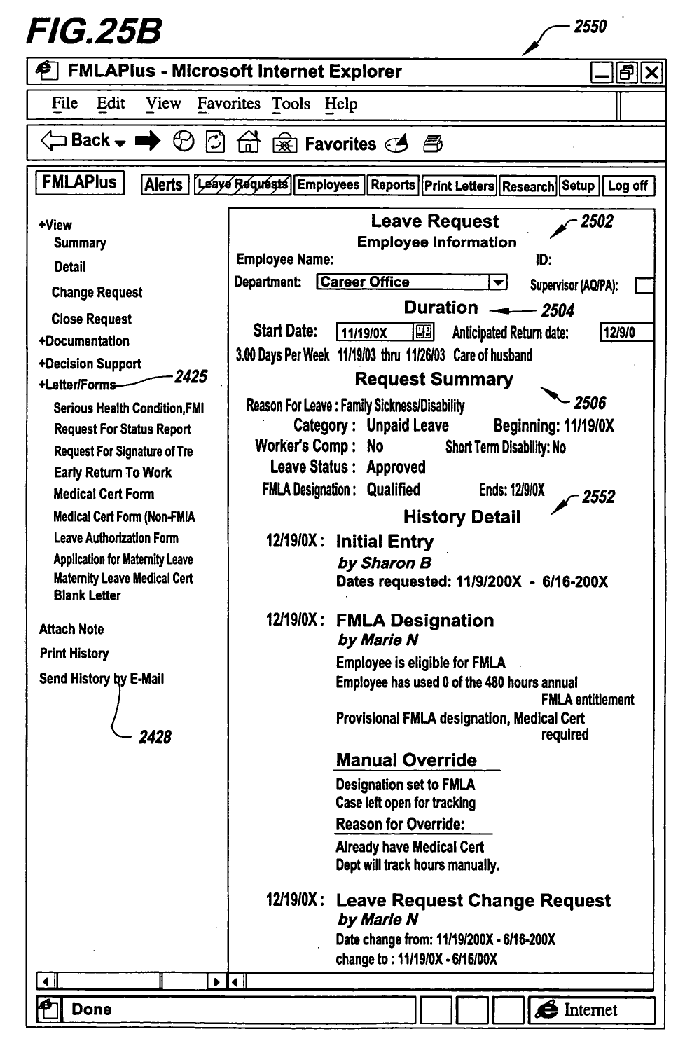

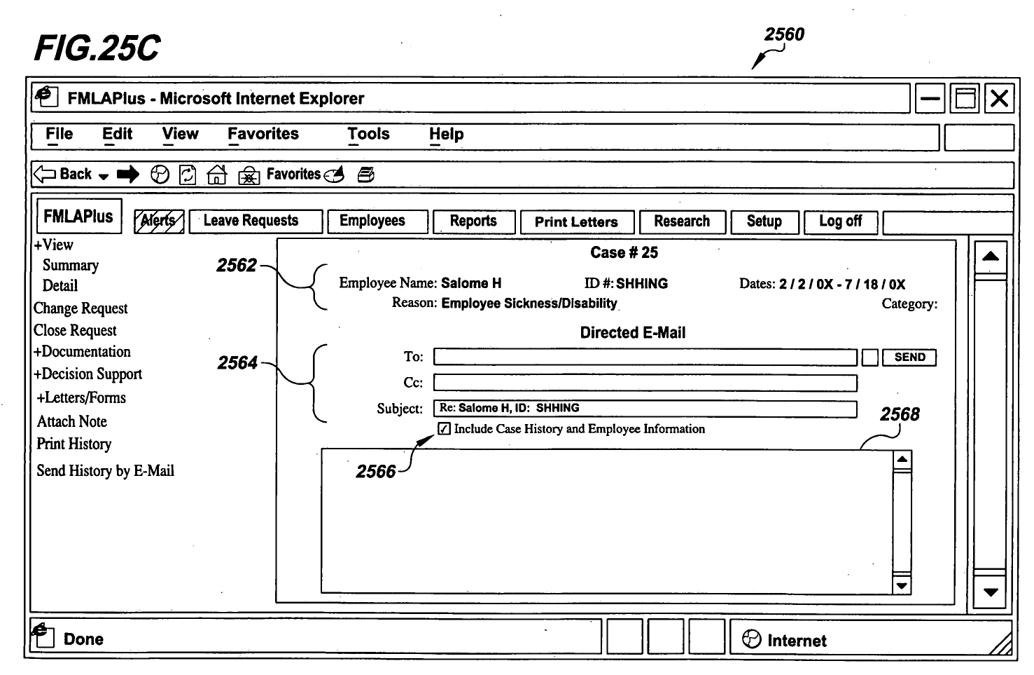

FIG. 25A is a leave request summary page 2500 prompted by an administrator selecting one of the employees listed in the reminder section 2252 (FIG. 22C) of the alerts page 2250 (FIG. 22C). The leave request summary page 2500 includes an employee information section 2502, a leave duration section 2504, and a request summary section 2506. The employee information section 2502 provides the name 2570 and ID 2571 of the employee, as well as the department 2572 the employee works in and the supervisor 2573 to which he or she reports. The duration section 2504 provides the start date 2574 of the leave and the anticipated return date 2575, and the type of leave (e.g., continuous leave) 2576. The request summary section 2506 provides a “snap-shot” of the leave status, including the reason for the leave 2577, category of leave 2578, 2580, and beginning dates 2579, 2581. For example, the employee is taking personal leave 2578 beginning Jan. 20, 200X (2579) and unpaid leave 2580 beginning Feb. 20, 200X (2581). Thus, the category of leave provides an indication of how or whether the employee is being paid during the leave. The request summary section 2506 further includes an indication of whether the employee is entitled to worker's compensation 2582 or short-term disability 2583, whether the leave is approved 2584, the status of the FMLA designation 2585, when FMLA entitlement ends 2586, and the FMLA hours 2587 expended in this leave.

The administrator may use this screen 2500 to make decisions as to how to handle the employee returning to work. Upon selecting the decision support item 2424, a drop-down menu 2508 of the various decision support processing trees is shown which enables the administrator to make a decision as to what type of processing will apply for that particular employee. As shown, the decision support trees address issues including whether the employee has a serious health condition 2590, whether job restructuring 2591 is needed, whether reassignment or light-duty work 2592 is needed for this employee, whether there are fitness for duty 2593 issues for this employee, whether the employee is terminating and not returning to work 2594, whether the employee has a condition falling within the scope of ADA 2595, and whether the employee is a key employee 2596. Upon selection of one of these menu items of the drop-down menu 2508, the administrator will be provided with a series of web-interface screens (not shown) to assist in returning the employee to work.

For more detail about this leave request and others for this employee, the administrator can select the view summary details item 2420 in the side menu 2402, and responsively, the summary details page 2550 is presented as shown in FIG. 25B. For every leave request, the absence management system 152 (FIG. 1B) establishes a history of that request. The summary details page 2550 includes similar sections to those shown in FIG. 25A, including the employee information section 2502, a leave duration section 2504, and a request summary section 2506. Further included in the summary details page 2550 is a history detail section 2552 that provides the history of leave requests for the corresponding employee. The case history can be sent to one or more individuals by selecting the send history by e-mail menu item 2428.

FIG. 25C illustrates an example e-mail page 2560 that can be used to send the case history of the employee. The e-mail page 2560 includes an employee information section 2562, an address section 2564, an option window 2566, and a notes window 2568. The employee information section 2562 includes the employee name and ID, the start and ending period of the leave, and the reason for the leave and category. The address section 2564 and notes window 2568 are similar to currently used e-mail systems, and thus the discussion of the same is omitted for brevity. The option window 2566 provides a mechanism to select whether to include the case history and employee information.

Directed e-mails to a designated individual or individuals can be achieved during return-to-work processing through the various web-interfaces used in decision tree processing, as explained below.

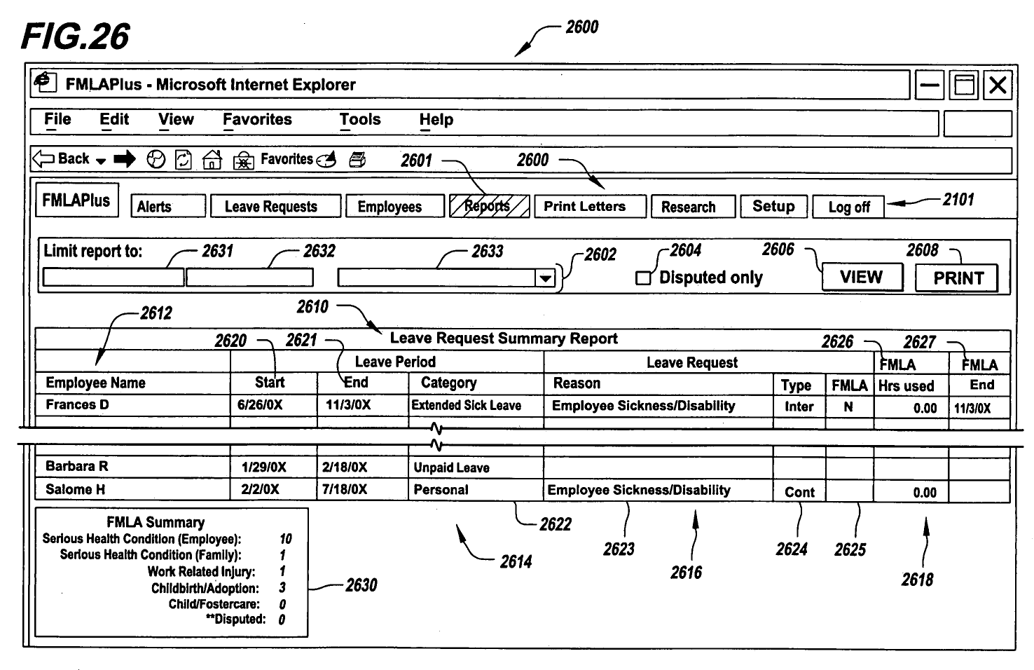

FIG. 26 is a screen diagram of an example leave requests summary report page 2600 responsive to selecting the reports icon 2601 from the main menu 2101. The leave requests summary report page 2600, in one embodiment, is a columnar report that lists each leave request and period in an operator designated date span. All leave requests which are open within the date span are preferably included. The leave requests summary report page 2600 includes a search criteria section 2602, a disputed checkbox 2604, and view and print button icons 2606 and 2608, respectively. Checking the disputed checkbox 2604 enables the generation of a disputed leave report (not shown), which would appear almost identical to the leave requests summary report page 2600 but preferably presented with only leaves that are disputed.

The leave request summary report page 2600 further includes a report section 2610, which includes an employee information section 2612, a leave period section 2614, a leave request section 2616, and a FMLA information section 2618. The report section 2610 preferably lists one line per request that falls within the date of ranges determined in the search criteria section 2602. The leave period section 2614 includes columns for start date 2620, end date 2621, and category 2622 for the leave requested. The leave request section 2616 includes columnar sections for the reason for the leave 2623, the type of leave (continuous, intermittent, reduced) 2624, and whether FMLA is designated (yes, no, pending) 2625. The FMLA information section 2618 includes columns for the hours used 2626 for the requested leave, and the end date for the requested leave 2627. Also included in the leave request summary report page 2600 is a FMLA summary section 2630, which provides a tally of the reasons for the leave.

The search criteria section 2602 enables the leave manager to set the beginning 2631 and ending 2632 report dates and department 2633, for example to produce quarterly reports. Responsive to selecting the view button icon 2606, the leave request summary report page 2600 is presented in the format as shown.

Note that in some embodiments, additional reports can be generated, such as reports (not shown) that illustrate trends in leaves by category, reason, etc., or by department, among others.

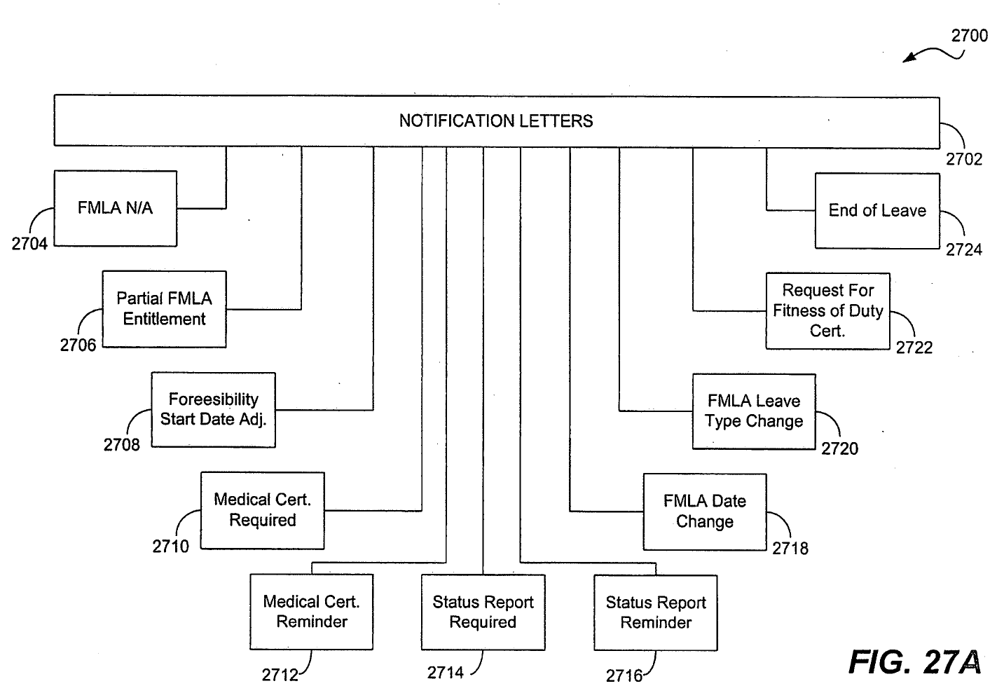

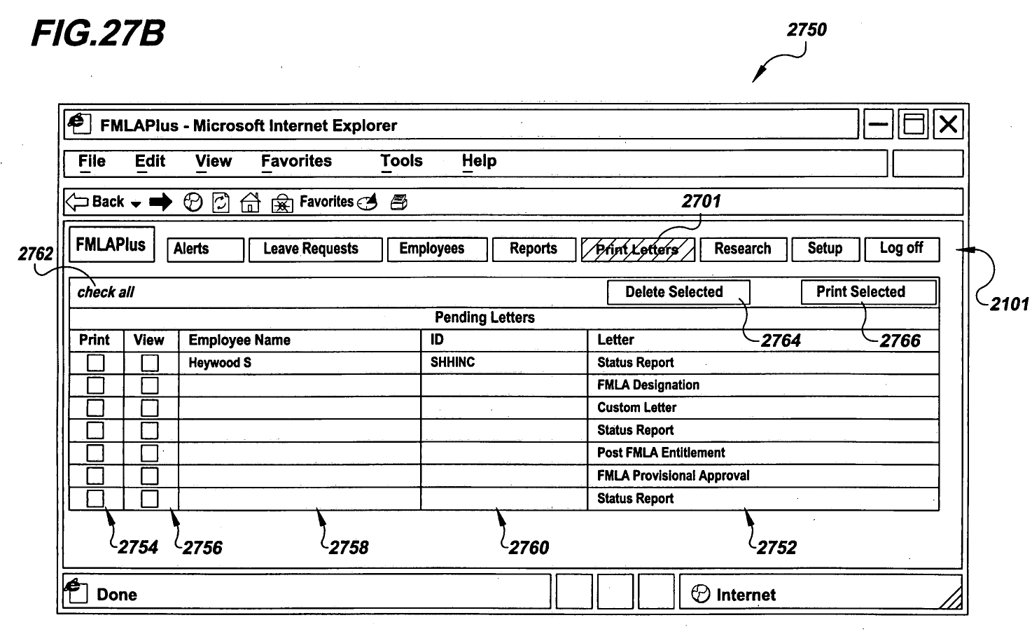

The absence management system 152 (FIG. 1B) provides for the generation of a plurality of notification letters, which are represented in the schematic diagram 2700 of FIG. 27A. These notification letters as represented in title block 2702, include FMLA not available (N/A) as represented by block 2704, partial FMLA entitlement as represented by block 2706, foreseeability start date adjustment as represented by block 2708, medical certification required as represented by block 2710, and medical certification reminder as represented by block 2712. Additional notification letters include status report required as represented by block 2714, status report reminder letter as indicated by block 2716, FMLA date change as represented by block 2718, FMLA leave type change as indicated by block 2720, request for fitness for duty certification as represented by block 2722, and end of leave letter as represented by block 2724.

Although the titles of these letters are self-explanatory to the function, several letters are further discussed below. For example, with regard to the notification letters, the FMLA not available letter represented by block 2704 is generated under the following circumstances. If the employee specifically requested FMLA as a reason for his or her leave, but the case cannot be designated FMLA due to eligibility or entitlement rules, the letter is generated. With respect to the partial FMLA entitlement letter represented under block 2706, if the employee's FMLA entitlement will not cover the entire leave request, a letter is preferably generated which indicates the ending date of entitlement based on the calculated hours. With regard to the FMLA date change letter represented by block 2718, if there has been a request for an extension or an early return, a letter is sent with the new date. With regard to the FMLA leave type change, represented by block 2720, if the leave is changed between continuous, intermittent, and reduced, an explanation letter is generated. Finally, with regard to the end of leave letter represented with block 2724, a final letter is generated indicating the end of FMLA designation, hours used, and reason for the end of the designation (e.g., return-to-work, reassigned, terminated, did not return-to-work, changed reason, began new case, etc.). The absence management system 152 (FIG. 1B) automatically generates the letter once the triggering event has occurred. The administrator can then edit, if necessary, and print and mail.

Note that notification letter generation may prompt reminders if they are due on a certain date (e.g., fifteen day reminder for medical certification), or if the leave manager chooses not to print a letter at the end of a process tree (e.g., non-designation of an explicitly requested FMLA leave). If there are notifications pending, they can be printed out individually or in batch. At the end of the printing process, the administrator may have the option of reprinting or sending the letters back to the notification alert state in case of printer malfunction.

FIG. 27B is a screen diagram of an example print letter screen 2750 prompted from an administrator selecting the print letters icon 2701 in the main menu 2101. From the print letter screen 2750, the administrator is preferably able to print pending notification letters as described above under notification alerts. This page can be prompted according to several mechanisms. For example, the example summary details page 2550 (FIG. 25B) includes a letters/forms menu item 2425 (FIG. 25B) that can drop-down when selected to illustrate the various sub-categories of items that can be selected, printed-out, and then sent. As shown, a list of pending letters is presented in the pending letters column 2752 for the particular employee. The print letter screen 2750 additionally includes a print option column 2754, a view letter option column 2756, an employee column 2758, and an ID column 2760 corresponding to the employee identified in the employee column 2758. The print option column 2754 provides the administrator with the ability to select which letter identified in the pending letters column 2752 to print out for the employee identified in the employee column and ID column (2758 and 2760, respectively). The view letter option 2756 enables the user to select to view the letter before it is printed out, enabling any editing that the administrator may desire to perform. The pending letters identified in the pending letters column 2752 include a status report, FMLA designation, custom letter, status report, post FMLA entitlement, FMLA provisional approval, and a status report.

Additional features of the print letter screen 2750 include a check-all icon 2762 to check all options listed in the print option column 2754, a delete selected button icon 2764 and a print selected button icon 2766 to delete and print, respectively, a selected option. Note that an employer can have the option of including whatever letters and forms they wish to be within the absence management system 152 (FIG. 1B). The letters can be generated automatically and/or manually. The summary detail list described above includes all letters/forms within the system 152. The print screen lists the identified letter generated for and related to each case. In some embodiments, combinations of letters and forms can be generated and sent that are identified in shorthand form. For example, when a provisional letter is sent, a medical certification form can be attached.

The absence management system 152 (FIG. 1B) provides for decision processing that includes a series of user interfaces to guide an administrator (or a manager) through the process of determining return-to-work and other absence-related issues. For example, under FMLA administration, the decision processing of the absence management system 152 provides a method for tracking potential FMLA cases and performing FMLA compliance functions. For medical documentation, the decision processing of the absence management system 152 provides for proper and appropriate request and uses of medical information and documentation. Further, decision processing enables strategies for coordinating leave and attendance policies with compliance obligations under such statutes as ADA, FMLA, and Worker's Compensation. Finally, the rights of employees and responsibilities of employers under such regulations as FMLA and ADA with respect to adverse employment actions are handled appropriately.

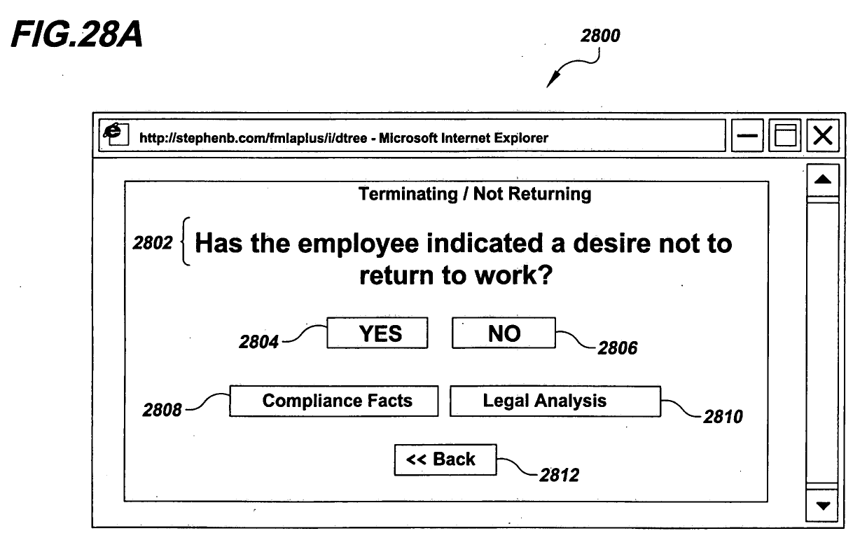

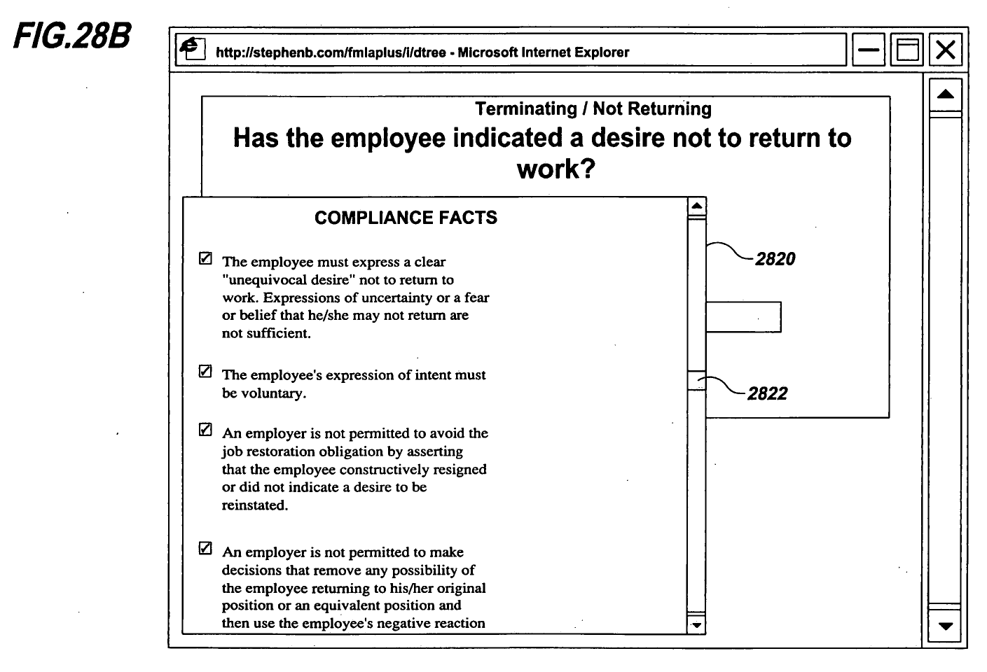

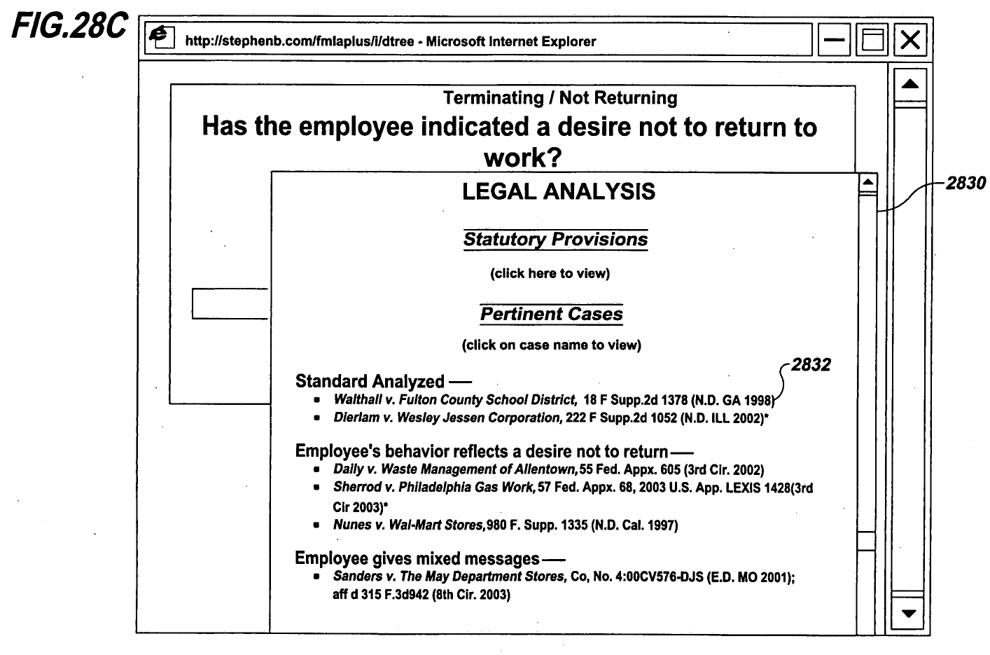

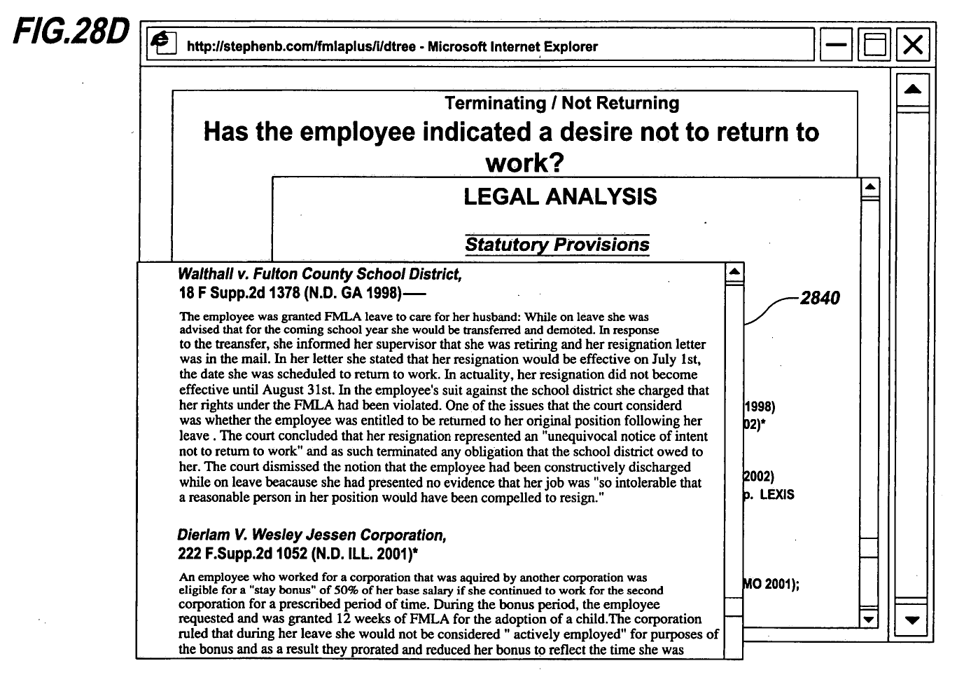

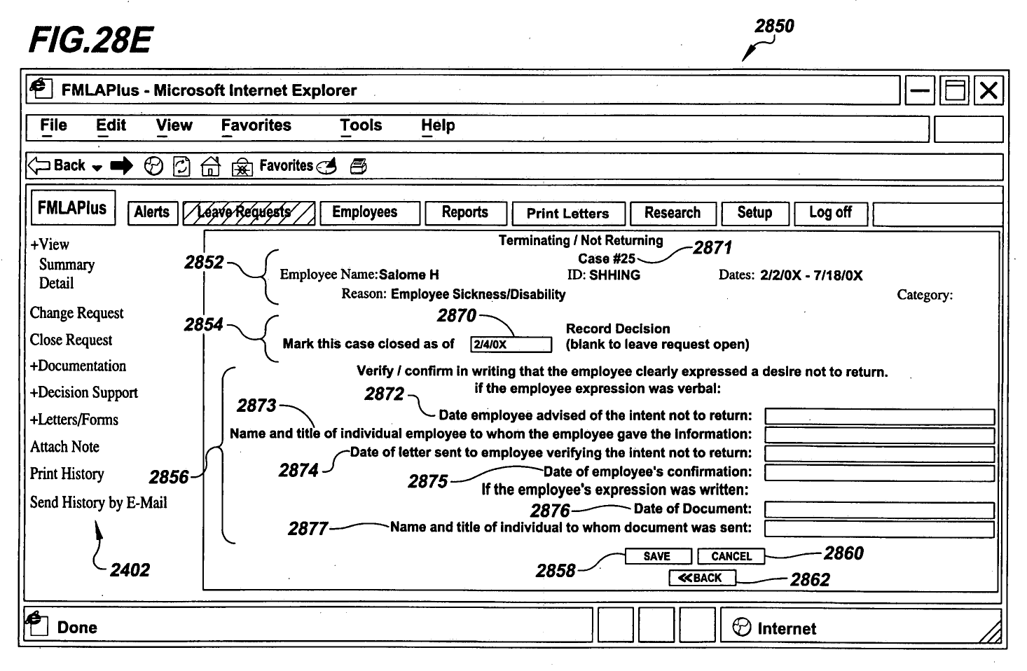

FIGS. 28A through 28E are screen diagrams that illustrate exemplary decision processing web-pages for a terminating/not returning triggering event for the employee. Note that other triggering events can follow a similar format. The decision tree pages guide a leave administrator or other responsible party through a series of questions needed to comply with return-to-work issues. The decision tree pages can be prompted from a side menu, such as by selecting the decision support menu item 2424 in the side menu in the side menu 2402 of the entitlement eligibility page 2400 of FIG. 24A. Also, the decision trees can be prompted for informational purposes by selecting the research icon 2401 of the main menu 2101 in the entitlement eligibility page 2400 of FIG. 24A, among other pages which provide for the side menu 2402 and/or main menu 2101.

Referring to FIG. 28A, an example terminating/not returning decision tree page 2800 is illustrated. The terminating/not returning decision tree page 2800 includes a query section 2802, a yes button icon 2804, a no button icon 2806, a compliance facts button icon 2808, a legal analysis button icon 2810, and a back button icon 2812. The query section 2802 provides a question to the administrator to help guide the administrator through return-to-work processing for a particular employee. In this example, the query section 2802 includes the question, “Has the employee indicated a desire not to return to work?” The administrator can respond “yes” or “no” by selecting the yes button icon 2804 or no button icon 2806, respectively. Otherwise, if the administrator needs some guidance on the statutory case law, the compliance facts button icon 2808 and legal analysis button icon 2810 can provide additional information for the administrator. In other words, the terminating/not returning decision tree page 2800 includes a research component that presents legal compliance facts, statutory provisions, and court decision summaries that an administrator can reference in case processing. In general, two ways an administrator can access a research function includes case processing and informational processing. In case processing, the administrator has access to research components to the decision tree being used to process a particular case or leave. In informational processing, an administrator consults or reviews legal data from decision trees that cannot be recorded in any case or leave. If an administrator enters a decision tree by selecting a return-to-work option, the case processing mode is preferably used. Selection of the research icon 2401 in FIG. 24A from main menu 2101 (FIG. 24A) is an example mechanism for prompting an information mode.

In response to selecting the compliance fact button icon 2808, an administrator is presented with a compliance fact overlay as shown in FIG. 28B. The compliance facts overlay 2820 presents the administrator with a series of facts that address the issue of what constitutes, for example, a desire not to return to work by an employee. For example, the first section of the compliance facts overly 2820 indicates that an employee must express a clear “unequivocal desire” not to return to work. Further, compliance facts are presented in the compliance facts overlay 2820, and can be scrolled through using the scroll bar 2822 in the overlay 2820. Note that, although shown as an overlay 2820, in some embodiments, the compliance facts can be represented in its own web page.

FIG. 28C is a legal analysis overlay 2830, which is prompted in response to a user selecting the user analysis button icon 2810 in FIG. 28A. As shown, the legal analysis overlay 2830 provides, in one embodiment, icons for selecting statutory provisions and pertinent cases to assist the user in determining an appropriate answer to the query from the query section 2802 of the terminating/not returning decision tree page 2800 (FIG. 28A). For example, in FIG. 28D, a case law overlay 2840 is presented in response to an administrator selecting one of the cases in the legal analysis overlay 2830 of FIG. 28C. In particular, an administrator in this example has selected the Walthall v. Fulton County School District icon 2832 in FIG. 28C to prompt the case law overlay 2840 in FIG. 28D. Note that the Dierlam v. Wesley Jessen Corporation case is also presented in the overlay 2840 by virtue of the fact that it follows the Walthall case, although this format is not necessarily so in some embodiments.

FIG. 28E is a screen diagram of a verification/confirmation page 2850, corresponding to the verification/confirmation block 906 of FIG. 9. The verification/confirmation page 2850 includes an information section 2852, a record decision section 2854, a verification section 2856, a save button icon 2858, a cancel button icon 2860 and a back button 2862. The information section 2852 is configured similarly to other pages, and thus, its discussion is omitted for brevity. The record decision section 2854 provides a window 2870 to enable a user to mark when the case was closed. In this example, “case number 25” 2871 was closed on Feb. 4, 200X as noted in the window 2870. Note that if the window 2870 was left blank, the leave request would remain open. The verification section 2856 assists the user in assuring that the employee's expression or desire not to return to work is properly documented. As shown, the verification section includes windows for user to enter information corresponding to various issues. For example, information such as the date the employee was advised not to return 2872 is included. Additional information includes the name and title of the individual employee 2873, to whom the employee gave the information, the date the letter was sent to the employee verifying not to return 2874, the date of the employee's confirmation 2875, and if the employee's expression was written, the date 2876 of the document and the name and title 2877 of the individual to whom the document was sent. To complete the verification/confirmation, the user simply selects the save button icon 2858. Otherwise, the user can cancel using the cancel button icon 2860 or return to prior pages for this decision tree by selecting the back button icon 2862.

In general, decision tree processing may operate under several operational rules. For example, all return-to-work options except return to original position have a corresponding decision tree. Additionally, all responses are recorded as part of the employee's leave history when a save button icon, such a save button icon 2858, is selected at the ending point of the decision. Finally, should an administrator choose to exit a decision tree, prior to completion, the history is not recorded. If the administrator returns to the same tree within one week or another designation period, it may restart in the same position and the choices made will be remembered.

Any process descriptions or blocks in flow charts should be understood as representing modules, segments, or portions of code which include one or more executable instructions for implementing specific logical functions or steps in the process, and alternate implementations are included within the scope of the preferred embodiments in which functions may be executed out of order from that shown or discussed, including substantially concurrently or in reverse order, depending on the functionality involved, as would be understood by those reasonably skilled in the art of the present invention.

It should be emphasized that the above-described embodiments are merely possible examples of implementations, merely set forth for a clear understanding of the principles of the absence management system 152 (FIG. 1B). Many variations and modifications may be made to the above-described embodiment(s) of the absence management system 152 and corresponding methods without departing substantially from the spirit and principles of operation and structure. For example, additional embodiments may be found in the commonly assigned provisional application referenced herein. All such modifications and variations are intended to be included herein within the scope of this disclosure.

1. An absence management system, comprising:
a memory with logic; and
a processor configured with the logic to track a leave from employment for an employee, said processor configured with the logic to provide return to work information that informs an administrator how to return the employee to work in compliance with employee leave laws.

2. The system of claim 1, wherein the processor is further configured with the logic to perform family medical leave act designations corresponding to the leave from employment.

3. The system of claim 1, wherein the processor is further configured with the logic to perform a family medical leave act eligibility determination, a family medical leave act entitlement determination, a family medical leave act qualifying determination, a designation for concurrent administration, a qualifying determination for concurrent administration, and a family medical leave act provisional designation.

4. The system of claim 3, wherein the designation for concurrent administration includes at least one of worker's compensation, short-term disability, extended leave, and maternity leave.

5. The system of claim 3, wherein the processor is further configured with the logic to generate employee notification letters regarding provision of medical certification based on the provisional designation.

6. The system of claim 1, wherein the processor is further configured with the logic to track and provide return to work information in compliance with at least one of federal laws and state laws.

7. The system of claim 1, wherein the processor is further configured with the logic to generate at least one of automatic alerts and letters during a period of tracking the leave from employment for the employee.

8. The system of claim 7, wherein the alerts include prompts to an individual that alert the individual to new requests for leave from employment, reminders corresponding to pending actions for the individual to perform, and requests that inform the individual of changes to a prior request for leave from employment.

9. The system of claim 7, wherein the automatic alerts includes a notification that at least one of a status report is not received, a medical certification is not received, a period corresponding to a family medical leave act designation has expired, and a leave period has ended.

10. The system of claim 7, wherein the automatic letters includes a notification of at least one of family medical leave act is not available, a partial family leave act entitlement, a forseeability start date adjustment, a medical certification is required, a medical certification is required reminder, a status report is required, a status report is required reminder, a family medical leave act date change, a family medical leave act type change, a request for duty certification, and an end of leave.

11. The system of claim 1, wherein the processor is further configured with the logic to prompt recordation of documentation corresponding to the leave from employment for the employee.

12. The system of claim 1, wherein the processor is further configured with the logic to record a case history for the leave from employment for the employee.

13. The system of claim 1, wherein the processor is further configured with the logic to prompt an alert based on a triggering event to an individual to initiate return to work processing that provides the return to work information.

14. The system of claim 13, wherein the triggering event includes a change in a work status of the employee.

15. The system of claim 14, wherein the change in work status includes at least one of reassignment/light-duty, job restructuring/modifications, terminating and not returning, request for leave extension, key employee, and fitness for duty.

16. The system of claim 1, wherein the return to work information includes a decision tree that include prompts for selectable yes and no responses to queries presented by the logic.

17. The system of claim 16, wherein the processor is further configured with the logic to provide an individual, responsive to entering a decision tree, with at least one of legal compliance facts, statutory provisions, and court decision summaries.

18. The system of claim 16, wherein the processor is further configured with the logic to provide access for an individual to a plurality of decision trees while in the decision tree.

19. The system of claim 1, wherein the processor is further configured with the logic to include at least one of employment statutes and employer policies in the return to work information.

20. The system of claim 1, wherein the processor is further configured with the logic to track the leave from employment for an employee in response to receiving a leave request.

21. The system of claim 1, wherein the logic includes a program embodied on a computer-readable medium.

22. An absence management system, comprising:
a memory with logic; and
a processor configured with the logic to provide a user interface that, in cooperation with an administrator, guides the administrator in decisions corresponding to returning an employee to work in compliance with employee leave laws.

23. The system of claim 22, wherein the user interface includes a question presented to the administrator to determine whether the employee has a change in work status as recognized by the employee leave laws.

24. The system of claim 22, the change in work status includes at least one of reassignment/light-duty, job restructuring/modifications, terminating and not returning, request for leave extension, key employee, and fitness for duty.

25. The system of claim 22, wherein the user interface includes facts corresponding to what constitutes compliance with employee leave laws.

26. The system of claim 22, wherein the user interface includes statutory provisions corresponding to employee leave law compliance issues.

27. The system of claim 22, wherein the user interface includes case law corresponding to employee leave law compliance issues.

28. The system of claim 22, wherein the user interface includes sections that enable the administrator to document events pertaining to the decisions corresponding to returning an employee to work in compliance with employee leave laws.

29. The system of claim 22, wherein the logic includes a program embodied on a computer-readable medium.

30. An absence management method, comprising:
receiving a leave request for an employee;
providing information to an administrator to facilitate administration of the leave of the employee in compliance with employee laws; and
providing directed guidance information to the administrator to facilitate returning the employee to work in compliance with the employee laws.

31. An absence management system, comprising:
means for receiving a leave request for an employee;
means for providing information to an administrator to facilitate tracking of the leave of the employee in compliance with employee laws; and
means for providing guidance information to assist the administrator in returning the employee to work in compliance with the employee laws.
